(19) United States
(12) Patent Application Publication
(10) Pub. No.: US 2007/0239464 A1
(43) Pub. Date: Oct. 11, 2007

(54) Networked System and Method for Formulating, Processing and Managing Challenges and Solutions

(76) Inventor: Darren J. Carroll, Wilmington, MA (US)

Correspondence Address: MINTZ LEVIN COHN FERRIS GLOVSKY & POPEO, 666 THIRD AVENUE, NEW YORK, NY, 10017, US

(21) Appl. No.: 10/575,131

(22) PCT Filed: Sep. 23, 2004
(86) PCT No.: PCT/US04/28808

§ 371 Date: Feb. 12, 2007

Related U.S. Application Data
(60) Provisional application No. 60/509,545, filed on Oct. 9, 2003.

(51) Int. Cl. G06F 19/00

(52) U.S. Cl. 705/1

(57) ABSTRACT

The invention relates to an improved networked system and method for formulating, processing and managing challenges and solutions.

### FIELD OF THE INVENTION

The invention relates to an improved networked system and method for formulating, processing and managing challenges and solutions.

### BACKGROUND OF THE INVENTION

A networked system for creating a community of people to solve problems in general is known. One example of such system is operated by InnoCentive, Inc. (“InnoCentive”), at Andover, Mass. InnoCentive's system has created a web-based community matching top scientists to relevant R&D challenges facing leading companies from around the globe. It provides an online forum enabling major companies to reward scientific innovation through financial or other incentives. In general the system matches “Seekers” and “Solvers.” A scientist (or other individual or entity) cam register as a “Solver” to gain access to opportunities to find challenges that match their skills and interest and receive professional recognition and significant financial rewards for finding solutions to the challenges. Companies (or other entities or individuals) seeking R&D (or other) solutions can post challenges for which they are seeking a solution, and become a “Seeker” to gain immediate access to a pool of leading scientific and other talent.

As part of the operation of the system, Seekers post R&D (or other) challenges to a website (or otherwise disseminate the challenge to notify some or all of the potential Solvers). Each challenge includes sufficient information to describe the challenge, the reward, the criteria and/or other challenge related information. Certain aspects of this information may be kept confidential. Some information may be available to all Solvers, and some information may be available to only Solvers meeting certain criteria. In some cases only a summary of the information is initially provided to the Solvers. Other alternatives exist.

The existing system enables the posting of information about challenges and receiving solutions for the challenges. However, there is a need for an improved system and method for these processes.

### SUMMARY OF THE INVENTION

One aspect of the invention relates to an improved networked system and method for enabling Seekers to pose challenges for Solvers.

Another aspect of the invention relates to an improved system and method for enabling Seekers to create and post challenges for Solvers in a networked system.

Another aspect of the invention relates to the overall system to facilitate the features and functions described herein.

Another aspect of the invention relates to various features and functions that facilitate a Seeker's interaction with the system.

Another aspect of the invention relates to various features and functions that facilitate the ability for a Seeker administrator to interact with the system and manage a portfolio on behalf of a Seeker.

Another aspect of the invention relates to various features and functions that facilitate a Solver's interaction with the system.

Another aspect of the invention related to features and functions that facilitate the ability for solvers to access the challenge and input solutions for the challenge. The features may include tools that guide a solver through the process of formulating a solution.

Another aspect of the invention relates to features and functions that facilitate evaluating the solutions provided by the solvers. The solutions may be evaluated against the criteria associated with the challenger.

The features of the invention may facilitate ranking and selecting the solutions for a reward. The features of the invention may also facilitate retrieving data and/or documents associated with the solvers who provided the winning solution, so as to process the reward.

Another aspect of the invention relates to various features and functions that facilitate the ability for a system administrator to interact with the system and manage a information relating to system administration, Seekers, Solvers, Challenges, and Solutions.

Another aspect of the invention relates to various features and functions that facilitate the ability for a mediator (e.g., scientific mediator) to interact with seekers, solvers and other users.

Another aspect of the invention relates to various features and functions that facilitate the ability for a mediator (e.g., scientific mediator) and other authorized users to access, review and modify the challengers provided by the seekers and/or solutions provided by the solvers.

Another aspect of the invention relates to various features and functions that facilitate the ability to maintain confidentiality and protect and manage intellectual property rights in connection with the operation of the system.

Another aspect of the invention relates to various features and functions relating to project rooms that can be used with the system.

Another aspect of the invention related to features and functions that facilitate communications among a seeker, an administrator or other intermediator, and a solver. The features may include project rooms for receiving and exchanging messages.

Another aspect of the invention relates to various features and functions that facilitate the ability to create virtual and/or private communities for use in connection with the invention.

Another aspect of the invention relates to the ability to use alerts to enhance the overall value of the system.

Another aspect of the invention relates to various features and functions that facilitate the ability to enable personalization features to be incorporated for use in connection with the system.

Another aspect of the invention relates to a modular system and method for managing, organizing and viewing challenges and solutions for the challenger.

Another aspect of the invention relates to providing template driven interface features for enabling a seeker or other authorized user to formulate and post a challenge, a solver to formulate a solution, a mediator to interact with seekers and solvers, a mediator to access, review and modify the challengers and/or solutions and administrators to manage various processes of the invention.

Another aspect of the invention relates to a system and method to facilitate the creation and posting of challenges. According to one embodiment, the invention comprises a template driven interface that facilitates the ability for Seekers to create and post challenges for Solvers. By way of example, the interface may include one or more screens that guide a user through the process of creating a challenge. A user, as referred to in this context, is intended broadly to include someone who is accessing the system to create a challenge on behalf of a Seeker.

According to one embodiment of the invention, one of the templates may include a display that enables a user to select from options that will enable the user to create a new challenge or work with an existing one (for example one that has been stored). Existing challenges may be opened and modified or used as templates for new challenges.

One of the steps may involve providing user and/or Seeker identification and/or contact information. Another step may involve providing background information relating to the challenge. For example, this may include one or more types of information such as scientific background information, the Seeker's (or other company's) history relating to the challenge and/or other background information. Another step may involve providing detailed information regarding the challenge. This can include providing one or more of a detailed description, supporting information, solution criteria, award information and/or other detailed information. An option to attach relevant information (images, documents, audio files, video files or other attachments) may be provided to facilitate the ability to attach existing documents or other files created using a separate application that are stored on a hard drive, network drive or otherwise stored but accessible to the user. Another step may involve providing an Abstract or summary of the challenge. If desired the user can specify at an appropriate point in the process whether a reduction to practice is required or not and other relevant parameters.

Another step in the process may include providing information regarding resource requirements relating to the challenge. For example, the user may specify resources such as human resources, equipments, laboratory, computer processing, storage capacity, or other resources likely to be required to address the challenge.

Another step in the process may include providing information relating to potential Solvers. For example, this step may include identifying disciplines to which the challenge relates, specific categories within the disciplines, and/or other target solver information.

Another step may include providing information regarding available potential resources that may be useful in helping to solve the challenge. Such resources may include, for example, known experts, relevant science conferences, industry organizations, journals (or other publications), relevant patents and other potential resources that may be available to assist the solver in addressing the challenge.

Each or some of the foregoing steps may be facilitated by presenting to the user one or more templates (e.g., via a graphical user interface), which enable the user to click on options, use drop down or check boxes (and other GUI tools) to select text or other items, text boxes to enter text and/or other options. Each of the templates may include context sensitive help boxes that can be readily accessed by the user. Examples or sample entries may be provided in conjunction with the help boxes or may be separately provided.

After all of the desired information is specified, the system can present a summary of the information (entered for example in different screens) for review by the user all in one screen. Any attachments can be presented for review as well. From this screen the user can approve or modify any of the previously entered information and save the information.

According to one embodiment, the information can be saved as a Word document (or in other desired format). For example, the system can provide the user an option to specify the format in which the document should be saved, where the document should be saved and a file name for the document. According to another aspect of the invention, saved challenges previously prepared by the user can be saved and recalled for subsequent modification and/or for use as a template for new challenges. Once a challenge has been saved it can be posted to the network in accordance with the procedures established by the system operator. Other objects and features of the invention will become apparent from the following detailed description considered in connection with the accompanying drawings that disclose embodiments of the invention. It should be understood, however, that the drawings are designed for purposes of illustration only and not as a definition of the limits of the invention.

### BRIEF DESCRIPTION OF THE DRAWINGS

FIG. 1 illustrates an example of a system architecture for a challenge formulation, according to an embodiment of the invention.

FIG. 1A illustrates an example of a user interface of a challenge formulation system, according to an embodiment of the invention.

FIG. 2 illustrates an example of a contact information input utility of a challenge formulation system, according to an embodiment of the invention.

FIG. 3 illustrates an example of a background information input utility of a challenge formulation system, according to an embodiment of the invention.

FIG. 4A illustrates an example of a detail information input utility of a challenge formulation system, according to an embodiment of the invention.

FIG. 4B illustrates an example of a detail information input utility of a challenge formulation system, according to an embodiment of the invention.

FIG. 5A illustrates an example of a resource information input utility of a challenge formulation system, according to an embodiment of the invention.

FIG. 6 illustrates an example of a target area specification utility of a challenge formulation system, according to an embodiment of the invention.

FIG. 7 illustrates an example of a reference specification utility of a challenge formulation system, according to an embodiment of the invention.

FIG. 8 illustrates an example of a confirmation utility of a challenge formulation system, according to an embodiment of the invention.

FIG. 9A illustrates an example of a process of creating a challenge for solvers, according to an embodiment of the invention.

FIG. 9B illustrates an example of a process of creating a challenge for solvers, according to an embodiment of the invention.

FIG. 10 illustrates an example of a system architecture of a challenge processing system, according to an embodiment of the invention.

FIG. 11 illustrates an example of a system architecture of a challenge processing system, according to an embodiment of the invention.

FIG. 12 illustrates an example of a solution formulation system including input tools, according to an embodiment of the invention.

FIG. 13 illustrates an example of a challenge procession system including modules for processing challenges, according to an embodiment of the invention.

FIG. 14 illustrates an example of a challenge procession system including modules for processing solutions, according to an embodiment of the invention.

FIG. 15 illustrates an example of a challenge procession system including modules for processing solutions, according to an embodiment of the invention.

FIG. 16 illustrates an example of a challenge procession system including modules for processing awards, according to an embodiment of the invention.

FIG. 17 illustrates an example of a view of challenges including its abstract and award information, according to an embodiment of the invention.

FIG. 18 illustrates an example of a view of a list of challenges sorted based on award value, according to an embodiment of the invention.

FIG. 19 illustrates an example of a challenge overview interface, according to an embodiment of the invention.

FIG. 20 illustrates an example of a personalized interface for a user, according to an embodiment of the invention.

FIG. 21 illustrates an example of an interface for a challenge, according to an embodiment of the invention.

FIG. 22 illustrates an example of an interface for editing challenges, according to an embodiment of the invention.

FIG. 23 illustrates an example of an interface for inputting data for featured challenges, according to an embodiment of the invention.

FIGS. 24A and B illustrate an example of an interface for a featured challenge, according to an embodiment of the invention.

FIG. 25 illustrates an example of an interface for displaying challenges based on their subject matter, according to an embodiment of the invention.

FIG. 26 illustrates an example of an administrator user interface, according to an embodiment of the invention.

FIG. 27 illustrates an example of an interface for viewing challenges of a seeker, according to an embodiment of the invention.

FIG. 28 illustrates an example of an interface for viewing solver related information of a challenge, according to an embodiment of the invention.

FIG. 29 illustrates an example of a submission tracking interface, according to an embodiment of the invention.

FIG. 30 illustrates an example of a new message interface, according to an embodiment of the invention.

FIG. 31 illustrates an example of a message presentation interface, according to an embodiment of the invention.

FIG. 32A illustrates an example of a list for challenge management, according to an embodiment of the invention.

FIG. 32B illustrates an example of an edit interface for a list for challenge management, according to an embodiment of the invention.

FIG. 33A illustrates an example of a list for challenge management, according to an embodiment of the invention.

FIG. 33B illustrates an example of an edit interface for a list for challenge management, according to an embodiment of the invention.

FIG. 34 illustrates an example of a list within a category for challenge management, according to an embodiment of the invention.

FIG. 35 illustrates an example of a list for challenge management, according to an embodiment of the invention.

FIG. 36 illustrates an example of an edit interface for a list for challenge management, according to an embodiment of the invention.

FIG. 37 illustrates an example of a search interface for solvers, according to an embodiment of the invention.

FIG. 38A illustrates an example of an interface for listing solver search results, according to an embodiment of the invention.

FIG. 38B illustrates an example of an interface for viewing a solver information, according to an embodiment of the invention.

FIG. 38C illustrates an example of an interface for listing seekers, according to an embodiment of the invention.

FIG. 38D illustrates an example of an interface for listing intermediators, according to an embodiment of the invention.

FIG. 38E illustrates an example of an interface for listing administrators, according to an embodiment of the invention.

FIG. 39 illustrates an example of an interface for enabling a user to input comments, according to an embodiment of the invention.

FIG. 40 illustrates an example of a personalized interface for intermediators, according to an embodiment of the invention.

FIG. 41A illustrates an example of a process of a solver's interaction with a challenge processing system, according to an embodiment of the invention.

FIG. 41B illustrates an example of a process of a solver's interaction with a challenge processing system, according to an embodiment of the invention.

### DETAILED DESCRIPTION OF THE INVENTION

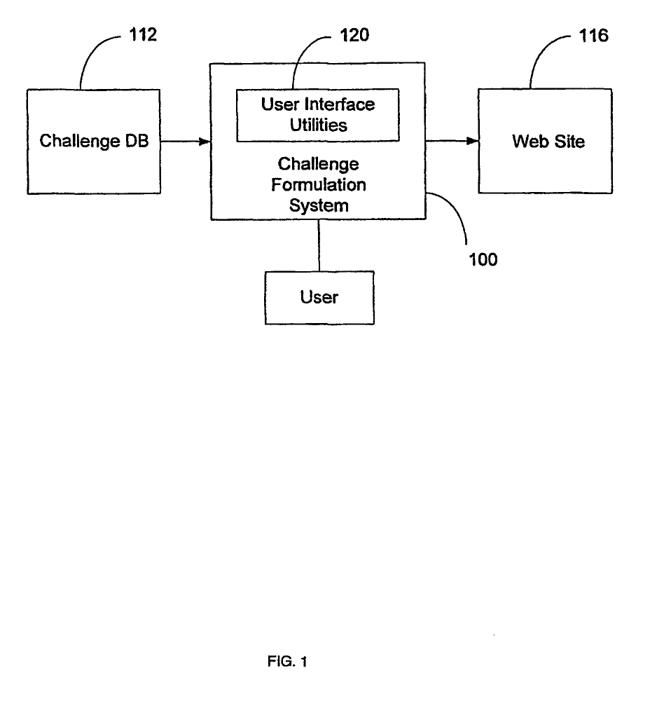

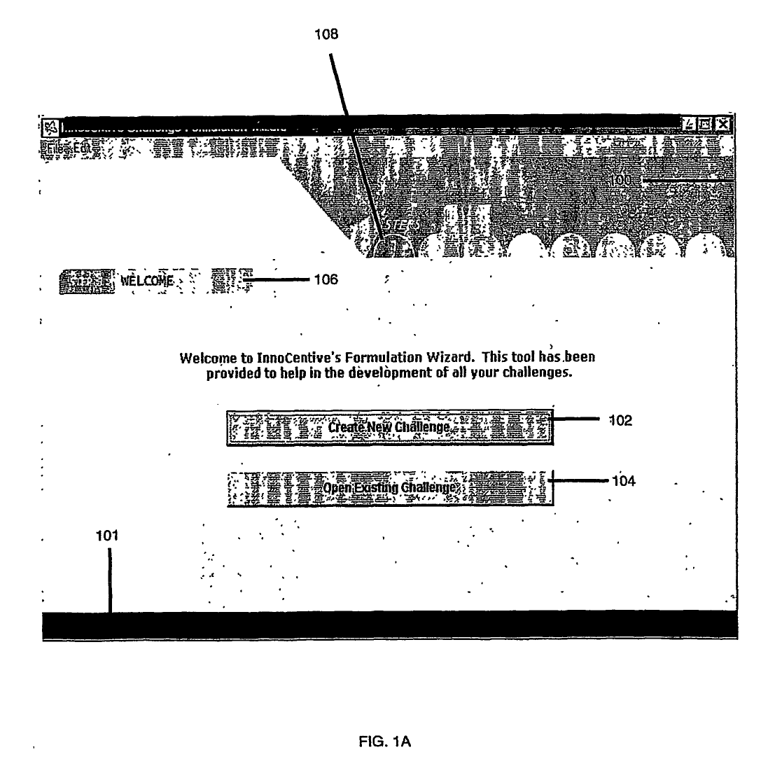

One aspect of the invention relates to a challenge formulation system and method to facilitate the creation and posting of challenges. As illustrated in FIG. 1, a challenge formulation system 100 may be coupled to one or more databases, for example, a challenge database 112 and a website 116 in a network. Challenge database 112 may be used for storing any new challenge or one or more of previously created challenges. Website 116 may be used for posting any new challenge or one or more of previously created challenges.

According to one embodiment, challenge formulation system 100 may include one or more template driven interface utilities 120 that may facilitate the ability for users (e.g., Seekers or other authorized intermediators) to create and post challenges for solvers. A user of challenge formulation system 100 may be an individual or an entity who is authorized to create, modify or post a challenge. In one embodiment, a user is a seeker who seeks to solve a challenge. In an alternative embodiment, a user is a middle-man or an entity other than a seeker and a solver. As illustrated in FIGS. 1A and 2-8, one or more template driven interface utilities 120 may include, for example, a challenge selection utility 101, a contact input utility 201, a background input utility 302, a detail information input utility 402, a resource input utility 502, a target area specification utility 602, a reference specification utility 702, and a confirmation utility 802.

According to the invention, challenge selection utility 101 may be used to enable a user to specify whether to create a new challenge or work with an existing challenge. According to one embodiment, challenge selection utility 101 may include one or more user selection objects, for example, a new challenge selection object 102 and an existing challenge selection object 104. A user or a Seeker may select new challenge selection object 102 for creating a new challenge and existing challenge selection object 104 for opening an existing challenge that was previously created and stored. An existing challenge may be opened or modified or may be used to create a new challenge using the existing challenge or portions thereof as a template.

In some embodiments, challenge selection utility 101 may include a message input tool 106. Message input tool 106 may enable a user to input a message, for example, a welcome message for Solvers.

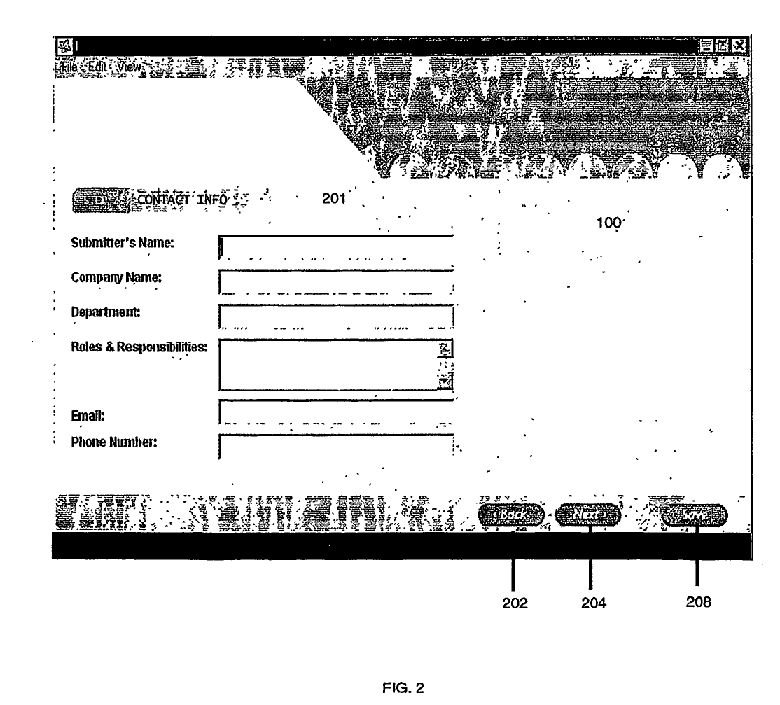

According to another embodiment, as illustrated in FIG. 2, contact info input utility 201 may include one or more features that enable a user to input the user's profile information, for example, but not limited to user's name, company name, department, roles and responsibilities, e-mail, phone, web-page or other contact related information.

During challenge creation, a user may need to provide sufficient as well as required information about a challenge so that a Solver can easily understand the challenge and work on the challenge. According to another embodiment, background input utility 302 may enable a user to input background information on a challenge. Background input utility 302 may include one or more input tools, for example, but not limited to a challenge name input tool 304, a scientific background input tool 308, a history input tool 308, etc. Furthermore, background input utility 302 may also include help features, for example, explanation help tool 310, example help tool 312 that may help a user input background information.

Challenge name input tool 304 may enable a user to input or provide a name for a challenge. Scientific background input tool 306 may enable a user to input scientific background information of a challenge, for example, importance of the challenge, prior scientific work, etc. History input tool 308 may enable a user to input user's or user's company history with the challenge, for example approaches that had been tried by the user or the user's company to solve the challenge. A user may also input confidential information within scientific background information or history information of a challenge. Background input utility 302 may include features for a user to specify any confidential information and authorize accessibility to one or more of other users.

In some embodiments, if a user needs help for inputting background information, a user may select explanation help tool 310a and/or example help tool 312a. In response to user selecting explanation help tool 310a, challenge formulation system 100 may provide a pop-up window that may include help information, for example, what type of scientific background information needs to be inputted, etc. In response to user selecting example help tool 312a, challenge formulation system 100 may provide a pop-up window that may include example information such as an example of a scientific background of a challenge.

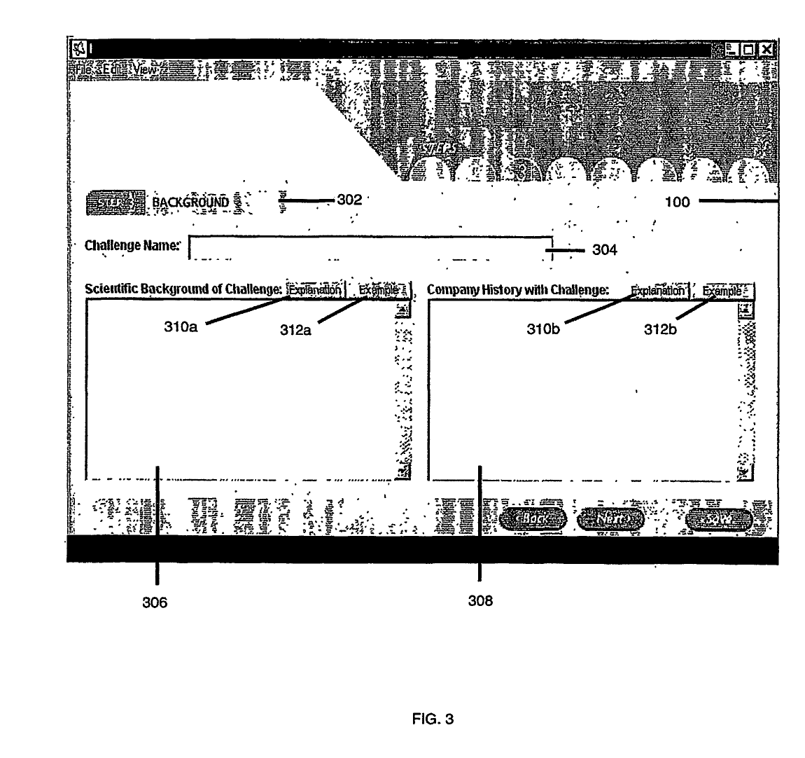

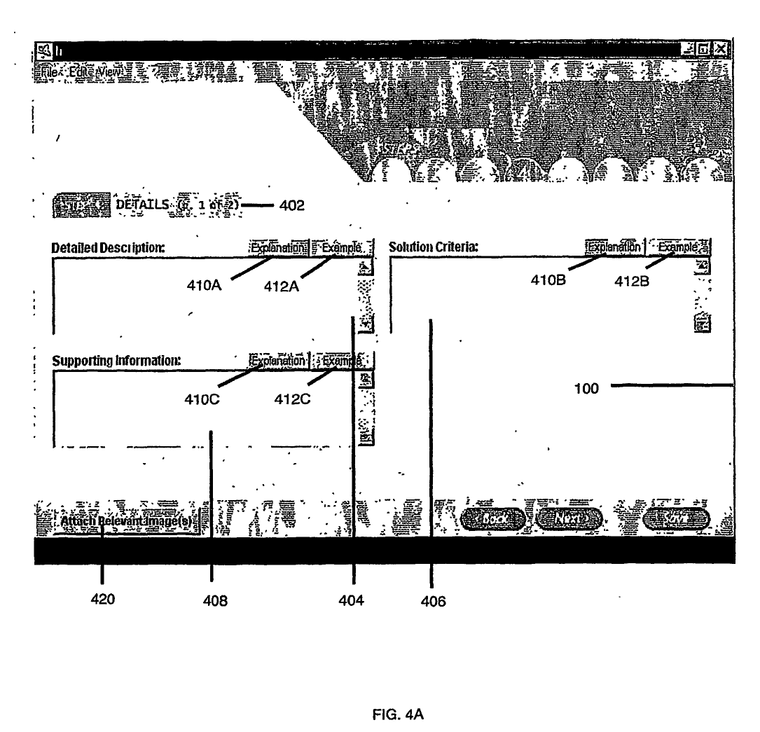

According to the invention, detail information input utility 402 may enable a user to input detailed information of a challenge. As illustrated in FIGS. 4A and 4B, detail information input utility 402 may include, for example, a detailed description tool 404, a supporting information tool 408, a solution criteria tool 406, an abstract input tool 424, and a summary input tool 426. Detailed description tool 404 may enable a user to input a detailed description of a challenge, for example, details of the challenge, details of the approaches that has been tried, etc. Supporting information tool 408 may enable a user to input supporting references, for example, relevant scientific literatures, web sites, or any additional information that could be provided to Solvers. Solution criteria tool 406 may enable a user to input a defined or specific solution criteria to solve a challenge. Solution criteria may include, for example, required methodology, materials to be avoided etc., to solve the challenge.

As illustrated in FIG. 4B, abstract input tool 424 may enable a user to input an abstract of a challenge. The abstract of a challenge may include one or more sentences. Summary input tool 426 may enable a user to input a summarized information of a challenge.

In some embodiments, details input utility 402 may include help features, for example an explanation help tool (410a-e) and an example help tool (412a-e) that may help users in deciding type of information to be inputted into detailed description tool 404, supporting information tool 408, solution criteria tool 406, abstract input tool 424, and summary input tool 426.

In some embodiments, detail information input utility 402 may include a document attaching tool 420 to attach additional relevant information (images, documents, etc.). Document attaching tool 420 may facilitate the ability to attach existing documents or documents created using a separate application that are stored on a hard drive, network drive or otherwise stored but accessible to the user. In some embodiments, a user may select attaching tool 420 to browse through a folder for selecting and retrieving a document from a hard drive, network drive or otherwise stored but accessible to the user.

According to another embodiment, as illustrated in FIG. 4I, details input utility 402 may include a specification feature 422 that may enable a user to specify, for example, whether or not a reduction to practice of the challenge is required.

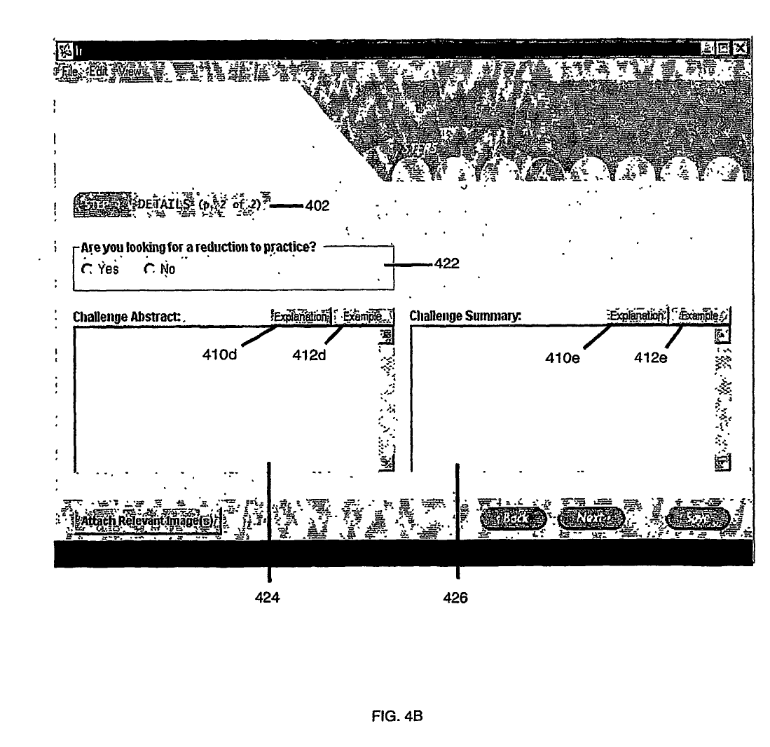

According to another embodiment, as illustrated in FIG. 5A, resource input utility 502 may enable a user to input one or more resources required to solve a challenge. The required one or more resources may include, for example, human resources, equipments, laboratory, computer processing or storage capacity, etc. In an exemplary embodiment, resource input utility 502 may include an input box 504 that may enable a user to input number and level of full-time staff required to solve the challenge. Resource input utility 502 may also include help tools (e.g., 510, 512).

According to another aspect of the invention, challenge formulation system 100, as illustrated in FIG. SA, may include a difficulty level specification utility 506 and a priority specification utility 508. Difficulty level specification utility 506 may enable a user to specify a level of difficulty (e.g., easy, moderate, difficult, extremely difficult) to solve a challenge. Priority specification utility 508 may enable user to specify a level of priority (e.g., low, moderate, high) of a challenge.

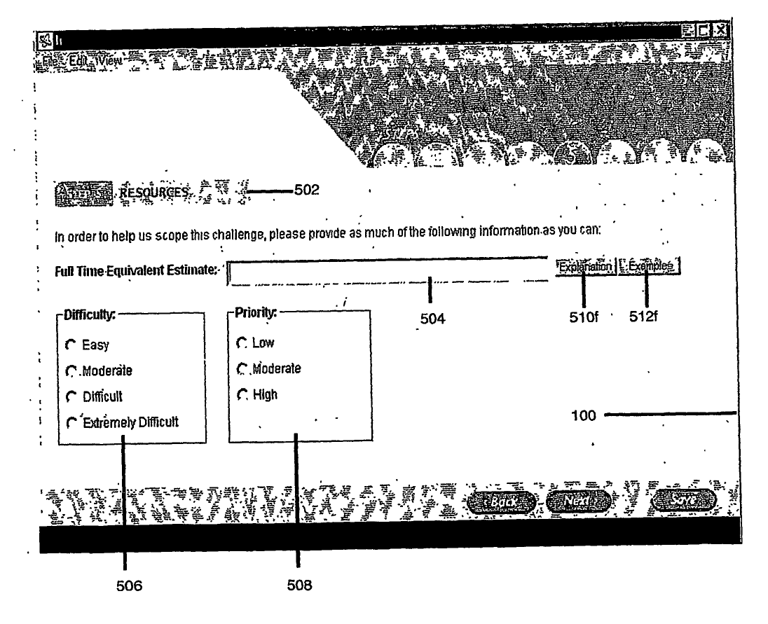

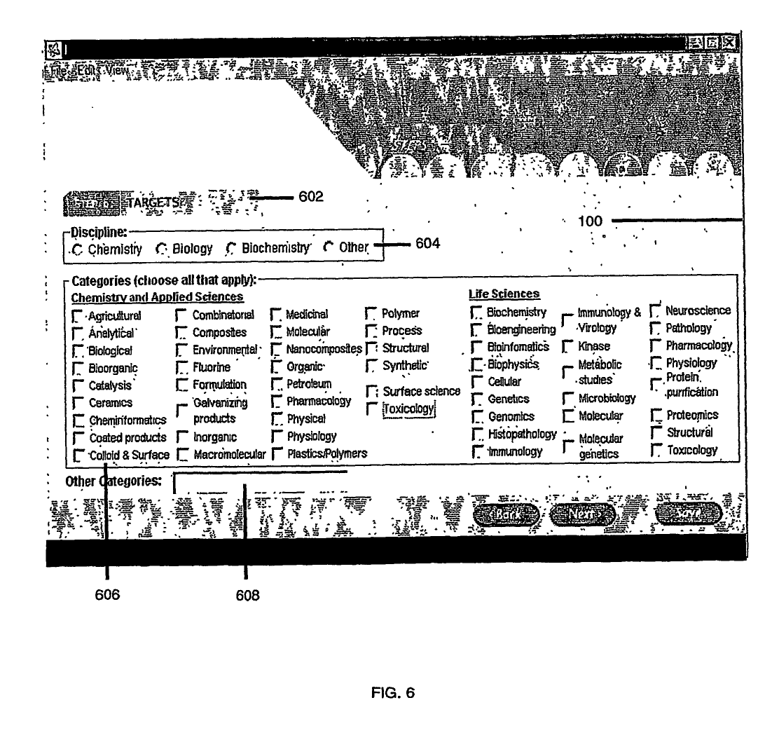

According to another embodiment, as illustrated in FIG. 6, target area specification utility 602 may enable a user to specify one or more target areas of science that may be related to a challenge. Target area specification utility 602 may include, for example, a discipline specification tool 604, a category specification tool 606, and other category tool 608.

Discipline specification utility 604 may enable a user to specify one or more broad disciplines related to a challenge. Category specification tool 606 may enable a user to specify one or more sub-categories that fall within one or more broad disciplines. Other category tool 608 may enable a user to specify other categories that do not fall within one or more broad disciplines.

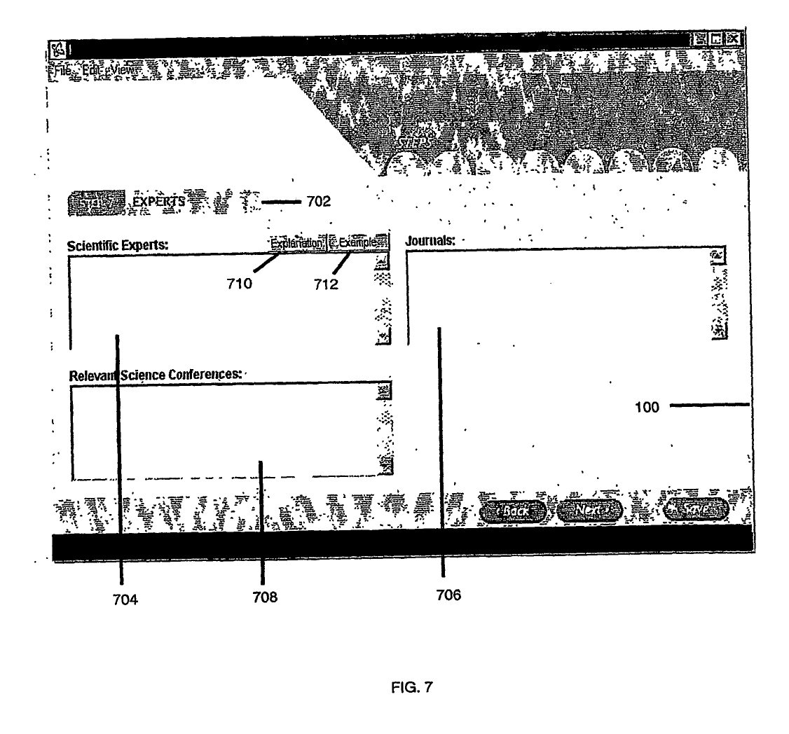

According to another embodiment, as illustrated in FIG. 7A, reference specification utility 702 may include one or more tools (e.g., 704, 706, and 708) that may enable a user to specify reference information related to a challenge, for example, scientific experts, journals, and relevant conferences related to the challenge. Reference specification utility 702 may also include help tools (e.g., 710, 712).

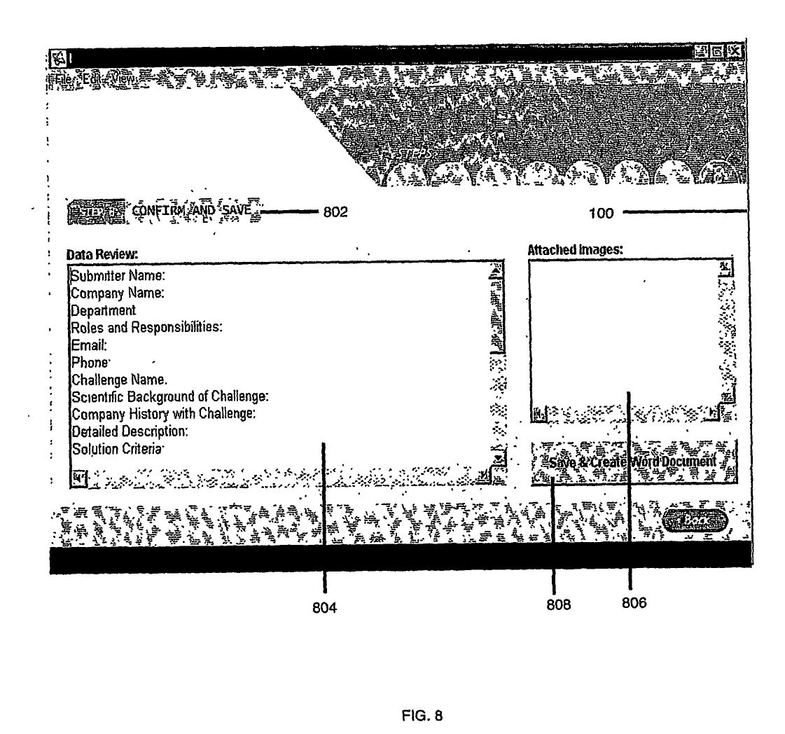

According to another embodiment, as illustrated in FIG. 8, confirmation utility 802 may enable a user for confirming and saving the inputted information and/or documents to solve a challenge. Confirmation utility 802 may include a data review tool 804 and a document review tool 806. A user may review the inputted information using a data review tool 804 and the attached documents using document review tool 806. Confirmation utility 802 may also include a save button 808. After reviewing the inputted data and documents, the user may save the created challenge by selecting save button 808.

According to another aspect of the invention, one or more template driven interface utilities 120 may also include various other features including a step indicator 108 and navigation tools as illustrated in FIGS. 1A and 2-8. Step indicator 108 may indicate, for example, a total number of steps in the challenge creation, the current step, the remaining number of steps to complete the challenge creation or other step related information. In some embodiments, template driven interface utilities 120 may include a navigation tool for enabling a user to navigate various steps in the challenge creation. As illustrated in FIG. 2, template driven interface utilities 120 may include a back button 202 and a next button 204 that may enable a user go back and forth various steps in the challenge creation. After inputting an information in each step, a user may save the inputted information by selecting, for example, a save button 208.

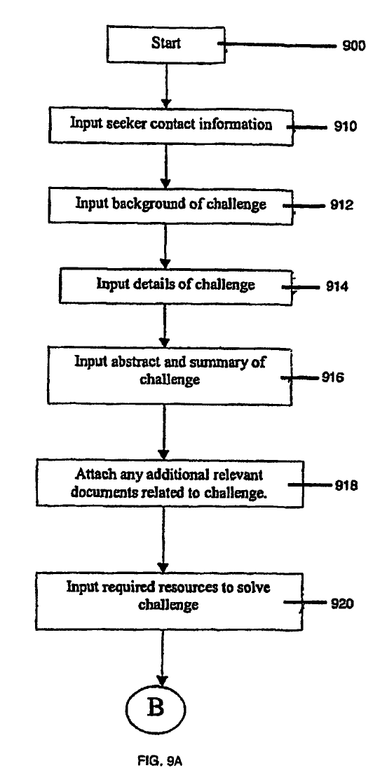

FIGS. 9A and 9B illustrate a process of creating a challenge for Solvers, according to the invention. As shown in operation 910, a user/Seeker may input his/her contact information for Solvers. As shown in operation 912, a user may input background information of a challenge. Background information may include, for example, scientific background of a challenge, user's history in solving the challenge, etc. As shown in operation 914, a user may input detail information of a challenge. Detail information may include, for example, detailed description of the challenge, supporting information (e.g., relevant literatures, website, etc.) for the challenge, solution criteria (e.g., defined or specific methodology to be used for solution, etc) for solving the challenge, etc. As shown in operation 916, a user may input abstract and/or summary information of the challenge. As shown in operation 918, a user may attach any additional documents (e.g., web or non-web documents, image files, etc.) related to the challenge. As shown in operation 920, a user may input required resources to solve the challenge. Required resources may include for example, human resources, equipments, laboratory, computer processing or storage capacity, etc.

As shown in operation 922, a user may set a level of difficulty (e.g., easy, moderate, difficult, extremely difficult) to solve the challenge. As shown in operation 924, a user may set priority (e.g., low, moderate, high) to solve the challenge. As shown in operation 926, a user may specify target scientific areas related to challenge. The user may also specify categories and sub-categories within the specified target scientific areas. As shown in operation 928, a user may input reference information, for example scientific experts, journals, conferences, related to the challenge. As shown in operation 930, a user may review the inputted data. As shown in operation 940, a user may save the data and authorize one or more Solvers to access the inputted data.

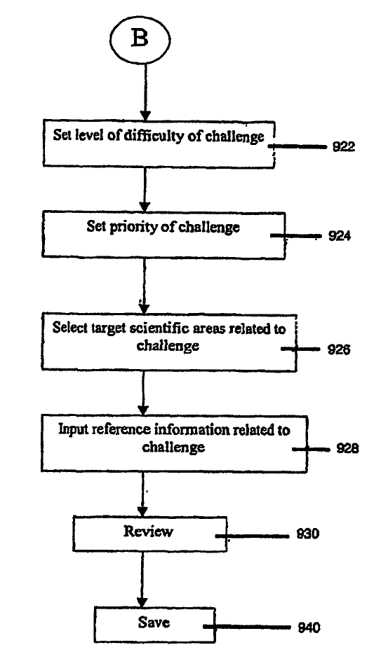

According to one aspect of the invention, as illustrated in FIG. 10, a challenge processing system 151 may be coupled to challenge formulation system 100 and solution formulation system 153. Challenge formulation system 100 may enable a user, for example a seeker or intermediator, to formulate a challenge for solvers. Solution formulation system 153 may enable a user to formulate a solution for one or more challenges. An intermediator (e.g., a scientific intermediator) and/or an administrator may coordinate various processes in challenge processing.

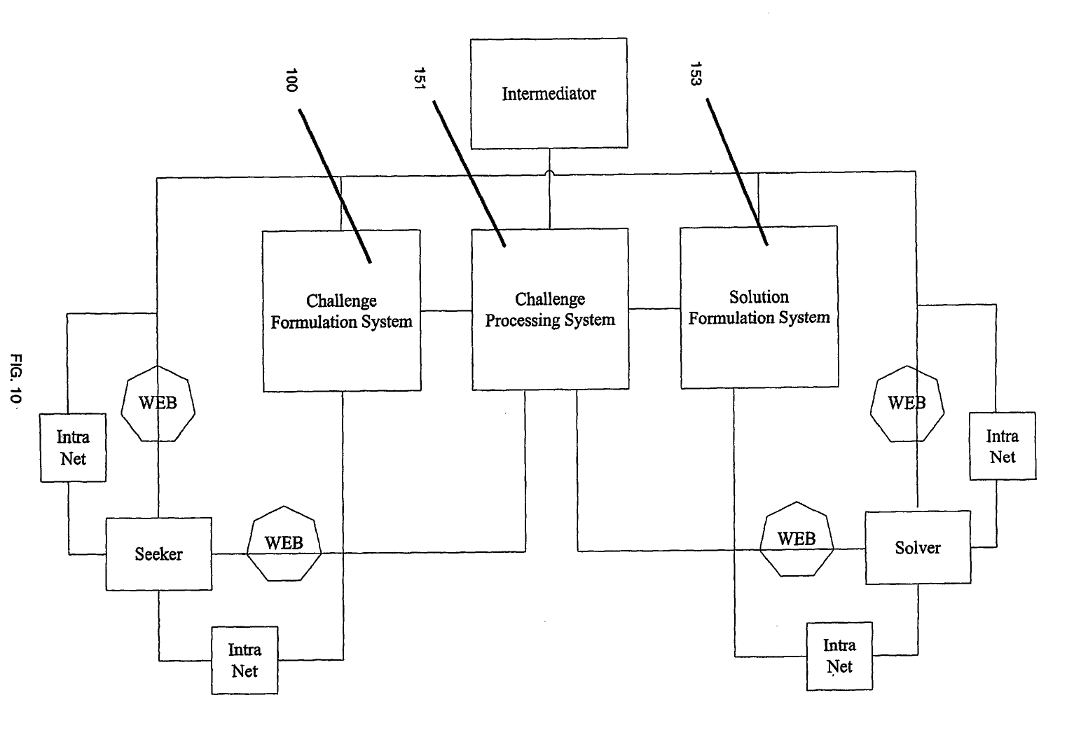

As illustrated in FIG. 11, challenge processing system 151 may be coupled to a plurality of databases including, for example, a challenge database 155, a solution database 159, an intermediator database 163. Challenge database 155 may store one or more challenges and their related information. In one embodiment, challenge database 155 may be coupled to an agreement database (not otherwise shown in Figures). The agreement database may include a plurality of kinds of agreements (e.g., Intellectual Property Assignment Agreements) for solvers, seekers and other users of various countries, states, etc. In another embodiment, challenge database 155 may be coupled to a seeker database 157. Seeker database 157 may include, for example, seeker contact information, seeker's area of interests, seeker's history with the challenges, seeker's communications with others, etc. Solution database 159 may include one or more solutions, for example, awarded solutions, declined solutions, etc., for one or more challenges. In one embodiment, solution database 159 may be coupled to an agreement database (not otherwise shown in Figures) that includes a plurality of kinds of agreements (e.g., Intellectual Property Assignment Agreements) for solvers, seekers and other users of various countries, states, etc. In another embodiment, solution database 159 may be coupled to a solver database 161. Solver database may include, for example, solver contact information, solver's expertise, solver's research background, solver's history data, solver's communications with others etc.

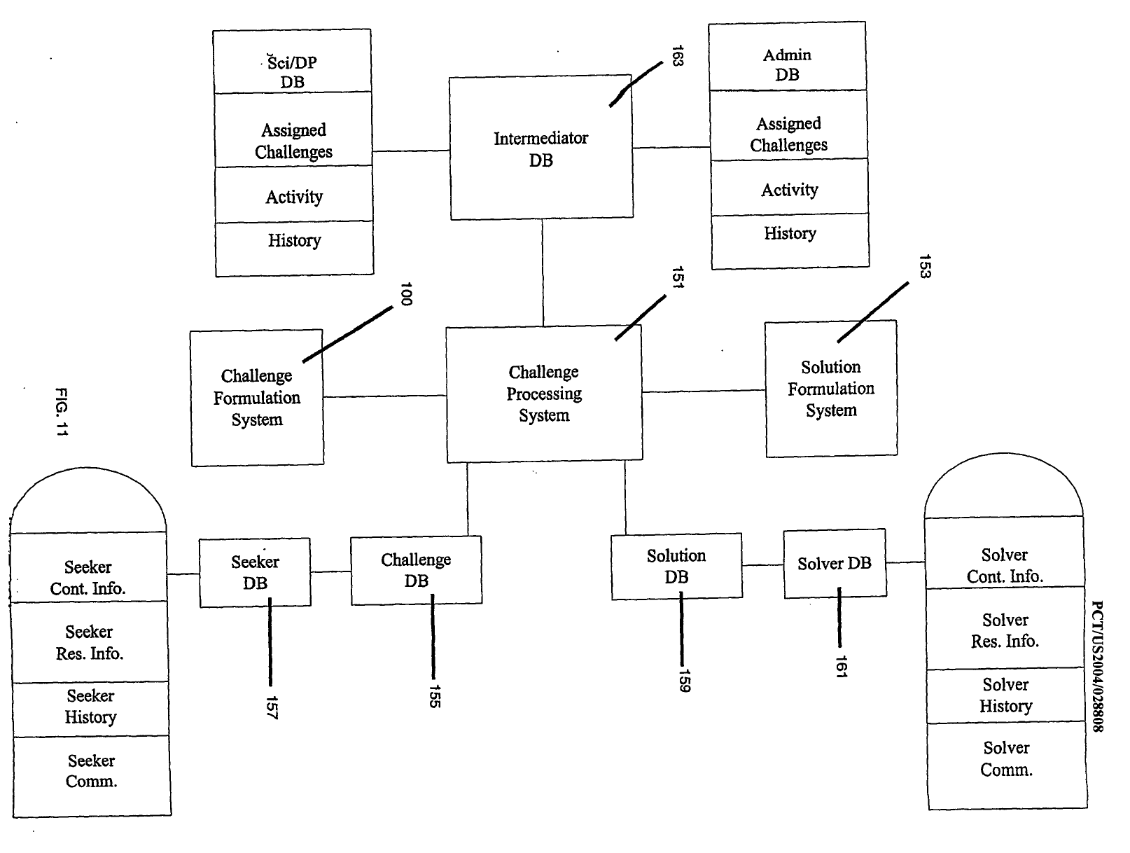

According to another aspect of the invention, as illustrated in FIG. 12, solution formulation system 153 may be coupled to a plurality of input tools, for example, a contact information input tool 171, a materials and methods input tool 172, a results input tool 173, a discussion input tool 174, a conclusion input tool 175, an additional required resource input tool 176, and a suggestion input tool 177. Contact information input tool 171 may enable a solver or other authorized users to input contact information such as name, e-mail address, etc. Materials and Methods input tool 172 may enable a solver to input materials and methodologies he/she used to solve one or more challenges. Discussion input tool 174 may enable a solver to input information related discussions on how the proposed solution may solve the challenge, etc. A solver may input conclusion information using conclusion input tool 175. If a solver needs additional resources, he/she may use additional requited resource tool 176 to input required resources. If a solver can not solve a challenge, but has suggestions for the challenge, the user may use suggestion input tool 177.

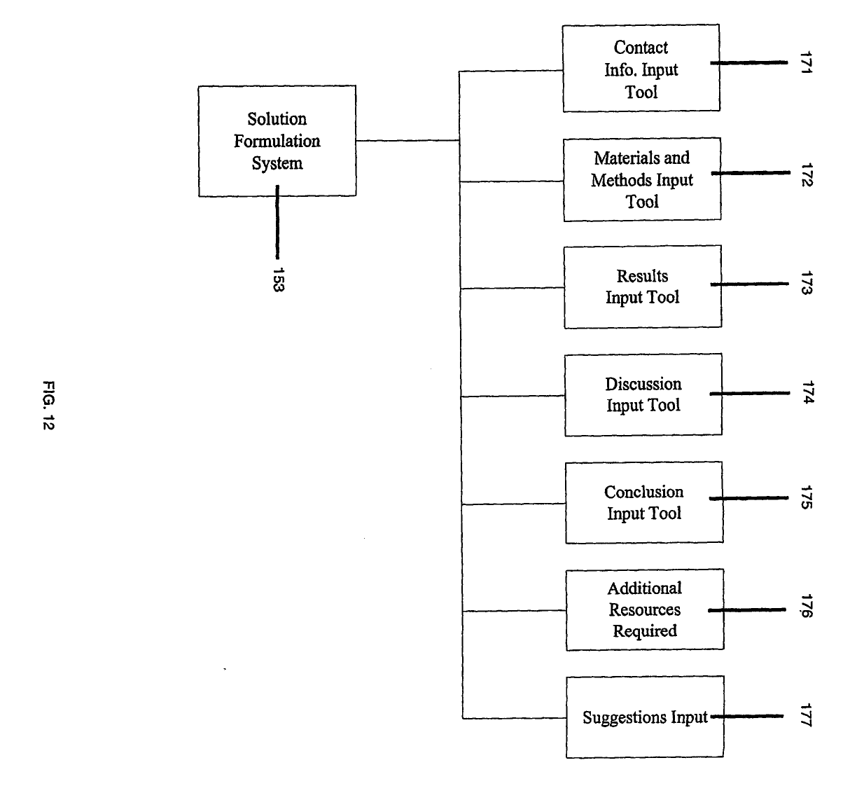

According to another aspect of the invention, as illustrated in FIG. 13, challenge processing system 151 may include a plurality of modules for processing challenges and solutions. The plurality of modules may include, for example, a challenge summary view module 178, a challenge detail view module 179, a challenge edit module 180, a challenge status module 181, a challenge tracking module 182, a challenge withdraw module 183, a challenge sorting module 184, a challenge searching module 185, a personalization module 186, a featured challenge module 191, and a challenge data maintenance module.

Challenge summary view module 178 may enable a user to view summary information of one or more challenges. Summary information may include, for example, brief summary of a challenge, deadline for solving the challenge, award related information, etc. Challenge detail view module 179 may enable a user to view details of one or more challenges. Details may include a detailed description for each of the one or more challenges, criteria for solving each of the one or more challenges, etc.

Challenge edit module 180 may enable a user (e.g., an admin., an intermediator, seeker, etc.) to modify or make changes on one or more challenges. Challenge edit module 180 may also enable a user to add one or more new challenges or delete one or more existing challenges.

Challenge status module 181 may enable a user (e.g., an admin., an intermediator, seeker, etc.) to view or input status information for one or more challenges. Status information may include, for example, information related to whether the solutions for the challenge have been reviewed, whether the award for the challenge has been made, etc. In some embodiments, challenge status module may include indicators (e.g., symbols, colors, etc.) for indicating the challenge status.

Challenge sorted module 184 may enable a user to sort one or more of the posted challenges based on one or more criteria including, for example, seeker, subject matter, date posted, challenge ID, etc. Sorted challenges may be presented to the user within a display. Challenge searching module 185 may enable a user to search a challenge based on one or more search criteria including, for example, seeker, subject matter, date posted, challenge ID, etc. In some embodiments, challenge search may be performed and search results may be presented to the user according to instructions specified by the user.

According to the invention, challenge processing system 151 may include a private room and a public room where the one or more challenges may be organized or stored. A public room may be accessed by any user in challenge processing system 151. However, a private room may be accessed by an individual to whom the private room has been assigned and the administrator in challenge processing system 151. Personalization module 186 may facilitate the ability for a user to organize one or more challenges within his/her private room. A user may add notes to each of the one or more challenges organized within his/her private room. These notes may not be accessible by the other users.

Featured challenges module 191 may enable a user to select one or more challenges and post the selected challenges on one or more predetermined websites as featured challenges. These featured challenge s may be special challenges (e.g., challenge of the month, challenge of the week, etc.) and may include a special award.

Challenge data maintenance module 192 may enable a user (e.g., an admin.) to perform maintenance operations on pending challenges, awarded challenges, and withdrawn challenges. Maintenance operations may include, for example, status update, linking challenges, linking solutions or other operations that would be apparent to the one skilled in the art. In some embodiments, challenge data maintenance module 192 may enable a user (e.g., an intermediator, an admin., etc.) to maintain or manage a portfolio of challenges for a seeker.

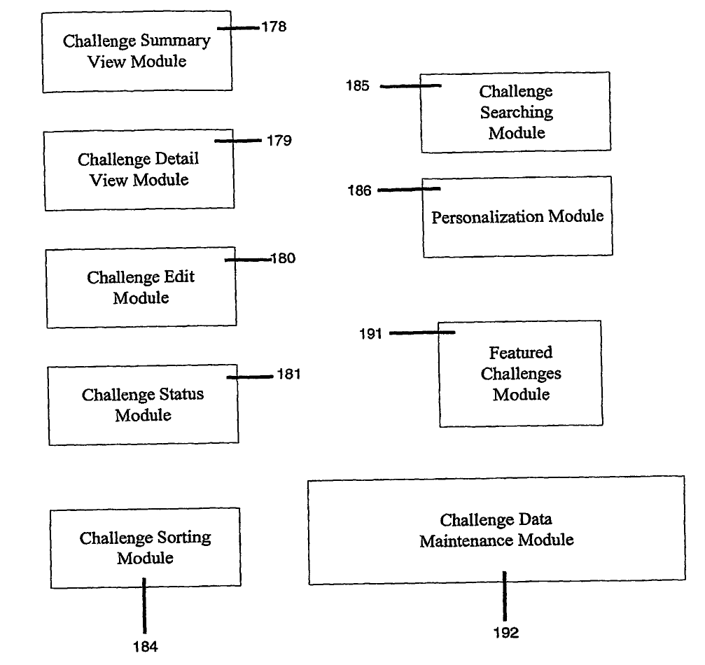

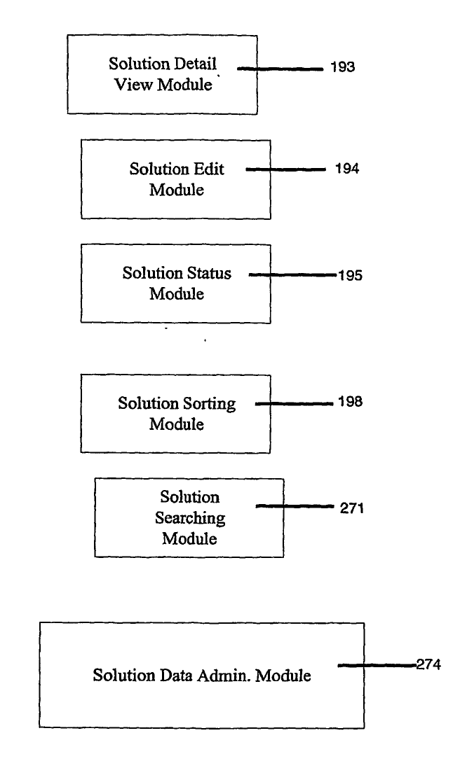

According to another aspect of the invention, as illustrated in FIGS. 14 and 15, challenge processing system 151 may include a plurality of modules for processing solutions. The plurality of modules may include, for example, a solution view module 193, a solution edit module 194, a solution status module 195, a solution sorting module 198, a solution searching module 271, a solution data administration module 274, a solution evaluation module 275, a criteria matching module 276, a solution ranking module 280 and a decision module 281.

Solution view module 193 may enable a user to view solution related information for a challenge. Solution related information may include, for example, summary of the solution, detailed description of the solution, references supporting the solution, etc. In some embodiments, solution related information may include, for example, a description of a wet sample or a prototype as part of the solution.

Solution edit module 194 may enable a user (e.g., Admin., solver, etc.) to modify or make changes on one or more solutions. Solution edit module 194 may also enable a user to add one or more new solutions or delete one or more existing solutions.

Solution status module 195 may enable a user (e.g., an administrator, an intermediator, solver, seeker, etc.) to view or input status information for one or more solutions. Status information may include, for example, information related to whether the solution has been reviewed, whether the award for the solution has been made, whether the solution has been declined, etc. In some embodiments, solution status module 195 may include indicators (e.g., symbols, colors, etc.) for indicating the solution status.

Solution sorting module 198 may enable a user to sort one or more of the submitted or pending solutions based on one or more criteria including, for example, solver name, subject matter of the solution/challenge, date submitted, solution ID, etc. Sorted solutions may be presented to the user within a display. Solution searching module 271 may enable a user to search a solution based on one or more search criteria including, for example, solver name, solver's geography data, subject matter of solution/challenge, date submitted, solution ID, etc. In some embodiments, solution search may be performed using a text based search query and the search results may be presented to the user according to instructions specified by the user.

Solution data administration module 274 may enable a user (e.g., an administrator) to perform maintenance operations on pending solutions, awarded solutions, and declined solutions. Maintenance operations may include, for example, status update, linking challenges, linking solutions or other operations that would be apparent to the one skilled in the art.

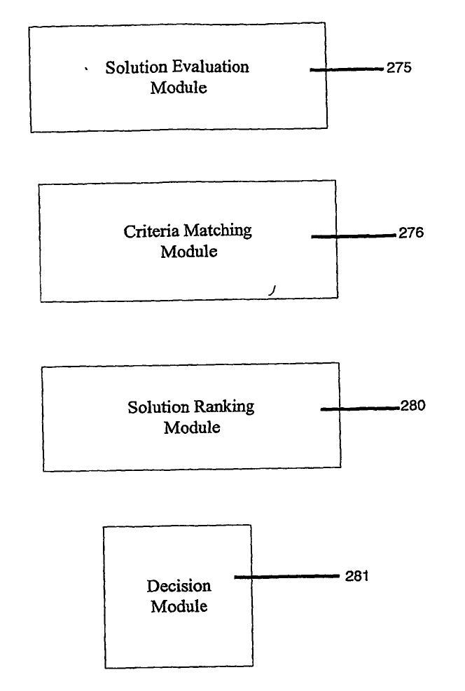

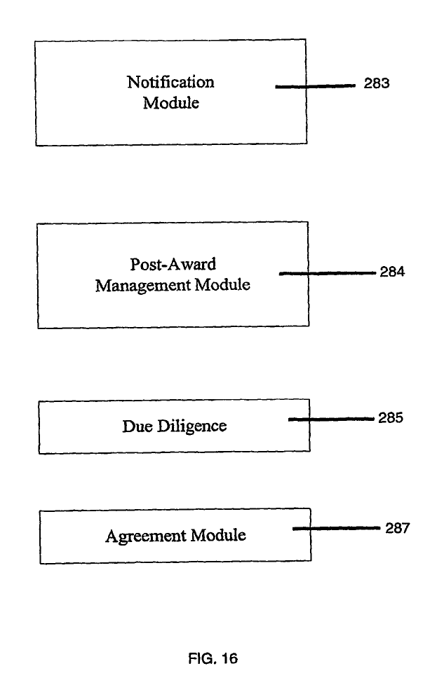

Solution evaluation module 275 may enable a user (e.g., an intermediator, a seeker, etc.) to evaluate one or more solutions for a challenge. Evaluation may be performed based on solution criteria associated with the challenge. The solution criteria may be specified by a seeker or intermediator for the challenge. In some embodiments, solution evaluation module 275 may be coupled to criteria matching module 276, solution ranking module 280, and decision module 281. Criteria matching module 276 may enable a user to evaluate the solutions based on the specified solution criteria. During the evaluation, the user may also add values or grades for each specified solution criteria. When a challenge includes more then one submitted solutions, the user may rank the solutions using a solution ranking module 280. Ranking may be performed based algorithms known to one skilled in the art. Decision module 281 may enable a user to make decisions (e.g., award, decline, etc.) on one or more solutions. In some embodiments, as illustrated in FIG. 16, notification module 283 may notify the decisions to the concerned one or more seekers by e-mail or other forms of notification tools known to one skilled in the art.

According to another aspect of the invention, as illustrated in FIG. 16, challenge processing system 151 may include a plurality of modules for processing awards for the challenges/solutions. The plurality of modules may include, for example, a notification module 283, a post-award management module 284, an agreement module 286, and an award release module 287.

Post-award management module 284 may enable a user to perform due diligence processes for one or more solvers/awardees. Post-award management module 284 may be coupled to agreement module 286 and award release module 287. According to the invention, agreement module 287 may retrieve one or more agreements for a solver or an awardee based on the information such as seeker related information (e.g., seeker's geography, seeker specified instructions, etc.) or solver related information (e.g., solver's residence, nationality, etc.). For example, if a seeker is based at Germany, agreement module 287 may retrieve Germany related intellectual property (IP) agreements for a solver or an awardee who solved the seeker's challenge. If the seeker is based at Germany, but specified challenge procession system 151 to include Germany, USA and Japan for IP agreements, agreement module 287 may retrieve Germany, USA, and Japan related intellectual property (IP) agreements for the solver or the awardee who solved the seeker's challenge. After the solver or the awardee signs or accepts the agreements (electronically or non-electronically), award release module 287 may release the award to the solver or the awardee who solved the seeker's challenge.

In some embodiments, one or more agreements may be provided to a user after the user registers in the challenge processing system 151. In one embodiment, agreement module 287 may retrieve and provide one or more agreements for a seeker after the seeker registers in the challenge processing system 151. The retrieval of the agreements for the seeker may be based on seeker inputted information, for example, seeker's place of business, etc. In another embodiment, agreement module 287 may retrieve and provide one or more agreements for a solver after the solver registers in the challenge processing system 151. The retrieval of the agreements for the solver may be based on solver inputted information, for example, solver's residence, etc.

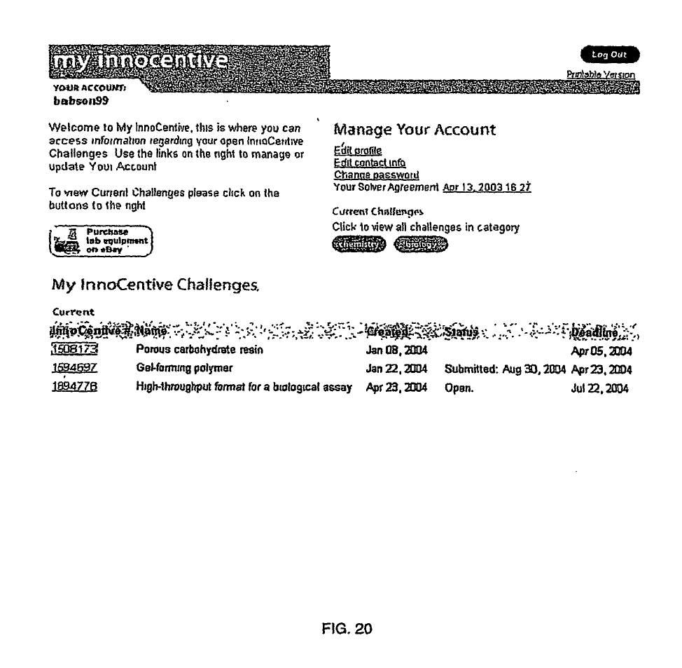

According to the invention, solvers may use challenge processing system 151 to sign the Solver Agreement, and to transfer ownership of their Solution to the Seeker Company if their Solution proposal is selected to receive an award. The Solver Agreement may include a non-disclosure agreement that may outline the Solution proposal review period and transfer of intellectual property rights to the Seeker Company for Solutions selected for an award. As illustrated in FIG. 20, the Solver can sign the agreement by clicking the “Sign Solver Agreement” button on the My Challenge page. In some embodiments, once the user has read the agreement, he can accept its terms by clicking the “ACCEPT” button (not otherwise illustrated in Figures). A Solver may sign the Solver Agreement once and it can be used to cover all Challenges posted to the website. In addition, in some embodiments, Seeker Companies may sign a Seeker Agreement to insure protection to the Solver regarding intellectual property rights of Solution proposals not selected to receive an award. This agreement may also outline the terms and conditions for working with a mediator or other users.

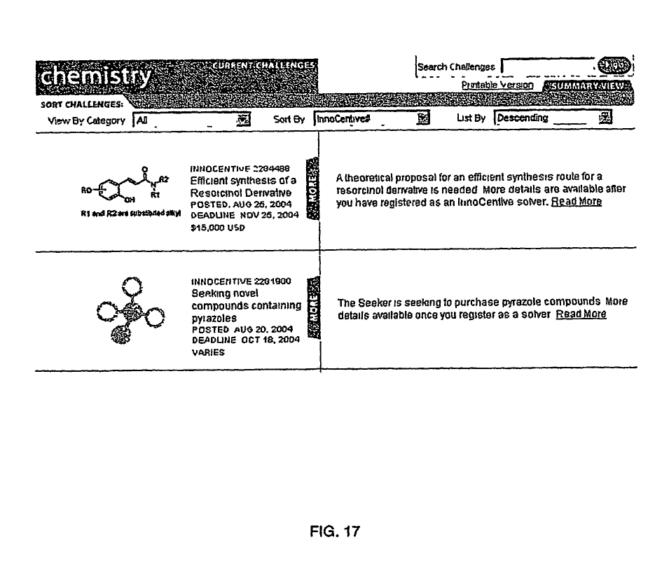

To work on a posted Challenge, a user may be a registered Solver and accept the Solver Agreement. Even if not registered, a user may review limited information about Challenges for example, a user may select a scientific discipline (e.g., chemistry or biology) and to search for Challenges of interest. As illustrated in FIG. 17 from the list of Challenges, the user may view the abstract of each Challenge, including the cash or other incentive, the deadline for submission of proposed Solutions, and other relevant information.

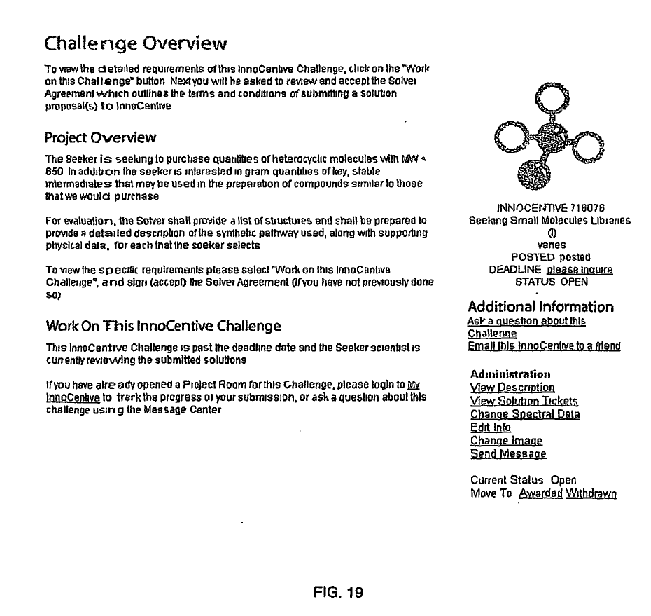

To access more detailed information on a Challenge, a user may be asked to register. A registered user can view Challenge details and the Solution submission criteria and becomes a member of the Solver community. This enables the user (optionally) to be notified by email of new Challenges and noteworthy news based on the selections and other information in the Solver profile. In some embodiments, to find out more about a Challenge, the user can click on a graphic associated with a Challenge of interest. The user may access and view the Overview of the Challenge page, which offers more information about the scientific problem as illustrated in FIG. 19.

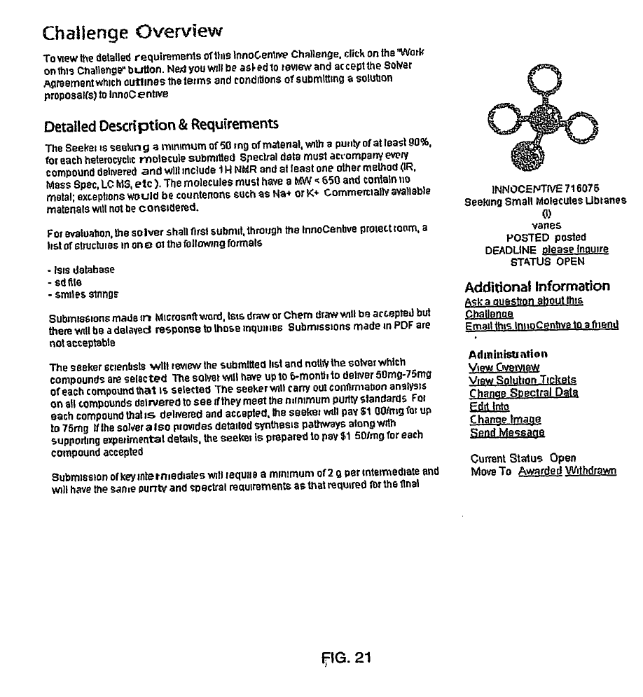

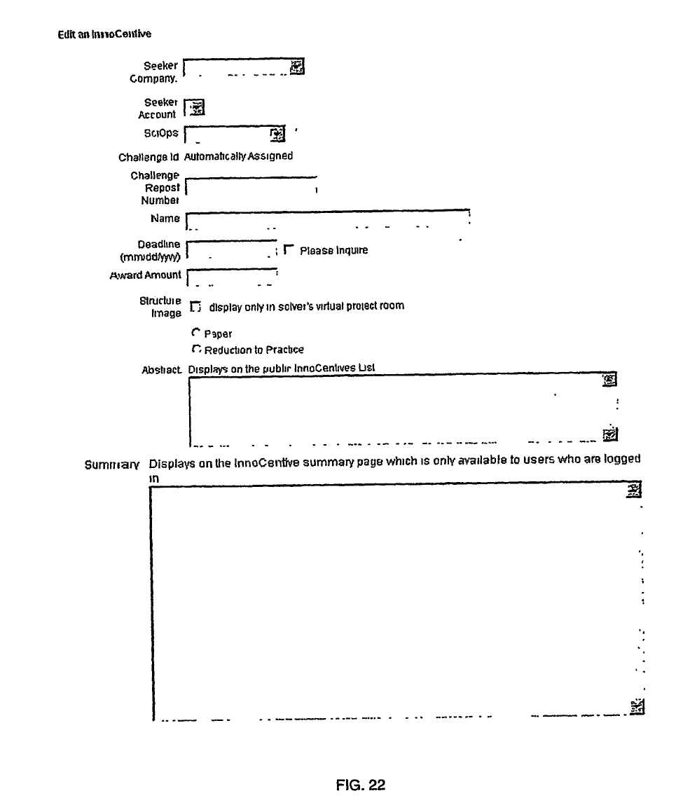

To select a Challenge to work on, the user can click on “Work on this Challenge” button as illustrated in FIG. 19. If this is the first Challenge and the user has not yet signed the Solver Agreement, this button may take the user to the Solver Agreement. If the user agree to the terms of the Solver Agreement, click the “ACCEPT” button to accept the agreement. If the user already has signed the Solver Agreement, clicking the “Work on this Challenge” button takes the user directly to the online Project Room for the Challenge, where the user will see the detailed description and Solution criteria as illustrated in FIG. 21.

The Project Room is a secure online area where users can ask questions about the Challenge, upload Solution proposals, and submit them. The user can use the “Messages” button to ask and receive answers to questions regarding the Challenge. Messages may be reviewed and answered daily by a intermediator of challenge processing system 151. The user may upload one or more Solution documents from the user's computer to a secure location at challenge processing system 151. Once the user has uploaded all the files for his Solution proposal, the user can click the “Submit A Solution” button to send the Solution proposal to the intermediator and the Seeker Company for review as illustrated in FIG. 21.

All Solution proposals may be validated by the Seeker Company and reproduced in a laboratory, if necessary. If the Solution proposal is accepted by the Seeker Company, the user is notified by challenge processing system 151. At this point, the user may be asked to complete a due diligence process. The due diligence process may include a verification of the user's identity, signing a brief Affidavit reaffirming the Solver Agreement, and signing of a Waiver document by the Solver's employer if applicable. Once the user has satisfactorily completed the due diligence process, the user may be awarded the cash incentive. Solvers may submit more than one Solution proposal, if desired.

In some embodiments, the Seeker Company understands the problem, describes the problem, and establishes the criteria/requirements for a Solution. Intermediator or other authorized user of system 151 may screen each Solution proposal to ensure that the Solvers have satisfied the submission criteria. If a Solution proposal is unsatisfactory, the Solver who submitted it may receive an email from the intermediator, outlining the areas of the proposal that did not meet the Solution criteria and asking the Solver to try again.

If more than one person submits the same Solution proposal, the Seeker Company may decide how to monitor submissions and pay the award. In the rare case of two identical Solution proposals being submitted to the Seeker, the Solver that submitted his/her Solution proposal first may receive the award. However, if two different, yet novel, Solution proposals are submitted, the Seeker Company may choose to pay more than one award to the individual(s).

The system may facilitate the ability to help protect both Seeker Companies and Solvers intellectually property. In some embodiments, only the intermediator and the Seeker Company that posted the problem can see any Solution proposals. In some embodiments, the Seeker Company and the Solver both sign an agreement protecting confidential information. In some embodiments, Solvers must be willing and able to transfer ownership of intellectual property to the Seeker Company. In some embodiments, solvers employer or other authorized ownership holder may transfer ownership of intellectual property to the Seeker Company.

Each Challenge may include a deadline for Solution proposal submission. Solutions may be presented by the posted deadline. When a Challenge is past deadline, Solvers may ask permission to work on it. In some cases, the Seeker Company may extend the deadline. To request permission to work on a Challenge that is past its deadline, the Solver may click the “please inquire” link in the Challenge Overview page as illustrated in FIG. 19. This may send a message to the science team who will, in conjunction with the Seeker Company, determine if the Solver can work on the Challenge.

Because it takes time to review and validate Solution proposals, a user may opt to receive email notification of the status of the Challenge. This notification may be sent when the Challenge is awarded or withdrawn. If no Solution is found, the Seeker may choose to modify the Challenge criteria and post the problem again. A registered user may opt to receive an email notification when new Challenges are posted to the site that match their scientific interests.

When a Solution proposal is selected by a Seeker Company, the Solver may be notified that his proposal has been selected. Shortly thereafter, he/she may be contacted by intermediator to complete a due diligence process. This may include providing challenge processing system 151 with his/her name, address, employer, Social Security number (if applicable), and bank account information (required to wire the award money to the account). The Solver may also sign an affidavit reaffirming his/her signing of the Solver Agreement for the specific Challenge. In some embodiments, the Solver's employer or other authorized ownership holder may sign the solver agreement.

Registering as a Solver gives Solvers the opportunity to find Challenges that match their interests and to receive professional recognition and significant financial awards for their Solutions. In some embodiments, though users can view abstracts of Challenges without registering, they must register to view detailed information and Solution criteria for posted Challenges and to submit Solution proposals. When a user registers, they may create an account profile and receive a username and password to log in to the site. When they choose to work on a Challenge, challenge processing system 151 may create a secure and confidential online Project Room for them to view the Challenge requirements, ask questions about the Challenge, and submit Solution proposals. If their Solution proposal is selected by the Seeker Company that sponsored the Challenge, they may receive the financial award. To receive the financial award, a user might also complete a due diligence process, in which challenge processing system 151 may collect information needed to pay the user the award and may verify that the user is able to transfer the intellectual property rights of the Solution proposal to the Seeker Company. To register as a Solver, the user may click a tab, which may take the user to the Login page (not otherwise illustrated in figures). From there, the user may click the “Register” button to begin the registration process.

The Registration process may include providing one or more of contact information (e.g., name, email address, and mailing address) and additional information such as a Work Sector, Company or Organization. The Work Sector may be the general area of science or other area the user does most of their work.

Additionally, the user may identify Scientific Interests. Scientific interests may be organized into various sections (e.g., Chemistry, Biology, Biochemistry, and Materials Science) other sections may be used. The user may check as many boxes as apply. In some embodiments, if the user wants to receive email updates about Challenges and other news in the areas specified, the user may check the phrase “I want to receive email updates” (not otherwise illustrated in figures). If the user does not want to receive email about these areas, the user can make sure the checkbox is unchecked. After the user has filled in this information, they can click the “Continue” button to go to the final registration page.

A user may also choose a username and password. Clicking the “Preview” button may take the user to a Preview page where they may edit any of the registration information, if necessary. To change any of the information, they may click the “edit” link in the area they want to change, make the changes, and click the “Continue” button to return to the Preview page. When satisfied with the account profile, the user may click the “Continue” button on the Preview page to complete the registration process.

In some embodiments, to complete registration, a registration verification email confirming the intent to register as a Solver may be sent to the email address the user provided. It may include a link to a special Account Verification login page. The user may click the link in the email and log in using their username and password.

Once the user has logged in from the Account Verification page, the registration process is finished. The user may then be taken to the My Challenge page, from which the user may manage the account and view the Challenges. My Challenge Page is illustrated in FIG. 20.

After registration, the field “Your Solver Agreement” on the My Challenge page may indicate “not signed.” This means the user has not yet signed the Solver Agreement. In some embodiments, until the user signs this agreement, the user may view only abstracts of Challenges, not detailed descriptions or Solution proposal criteria. As illustrated in FIG. 20, the user may click the Sign Solver Agreement button on their My Challenge page to sign the Solver Agreement. Or, the first time a user indicates they want to work on a Challenge, he/she may be presented with the Solver Agreement. In either case, once the user signs the agreement, he/she may have access to detailed descriptions of posted Challenges and be able to submit Solution proposals.

According to another embodiment, the invention provides features and functions for facilitating a personalized room, for example, My Challenge page for Seeker, Solvers, intermediators, and Administrators.

According to the invention, once an account has been verified, logging into challenge processing system 151 may take the user directly to his/her “My Challenge” page. “My Challenge” is where the user can manage or update his account, access information regarding his current and past Challenges, or view current Challenges. Features included in “My Challenge” may be different for seekers, solvers, intermediators and administrator (e.g., Sci Ops).

According to another embodiment, the invention provides features and functions for managing accounts for Seekers, Solvers, intermediators, Admins and other authorized users.

As illustrated in FIG. 20, the “Managing Your Account” links may allow a user to edit his profile, change his password, edit his contact information, upload a photo and take other direct actions. The “Your Solver Agreement” line in “Managing Your Account” shows whether the Solver Agreement is signed. If so, it shows the date signed. If not, it says “not signed.” The user may edit his profile as desired.

In some embodiments, if a user has not yet started to work on a Challenge, the “My Challenge” table may include only headings for rows of current and past Challenges. Once a user starts to work on Challenges, each Challenge the user is working on may be listed under “Current,” as illustrated in FIG. 20. Each Challenge the user has worked on where the user's Project Room has been closed—because that Challenge is either Solved or Withdrawn by the Seeker Company—may be listed under “Past.” Clicking on a Challenge ID # in the table may facilitate to access the Project Room for that Challenge. From there, the user may review the Challenge details, submit his/her Solution proposal, ask questions, and receive answers confidentially from intermiediators or other authorized users in challenge processing system 151. To ask questions and view answers to previously asked questions, the user may click the “Messages” button or click the “Messages” link near the top of the page as illustrated in FIG. 21. To submit a Solution proposal to the current Challenge, click the “Submit Solution” button (not otherwise illustrated in Figures).

According to another embodiment, the invention provides features and functions for viewing Challenges.

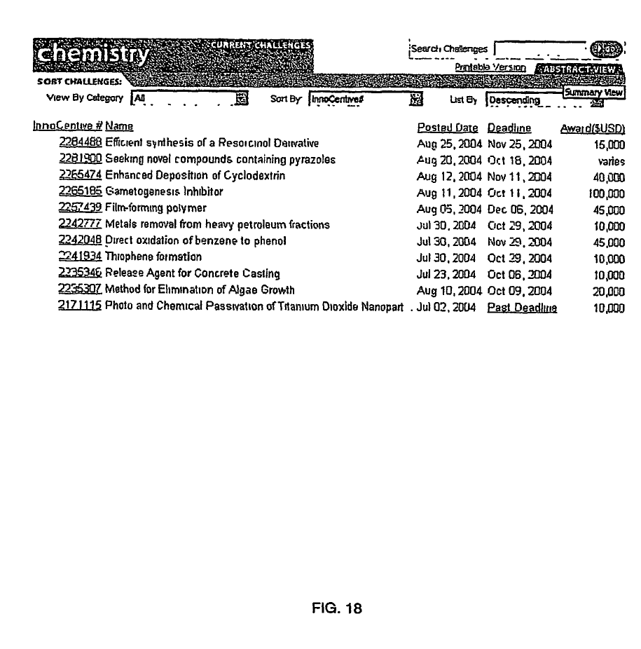

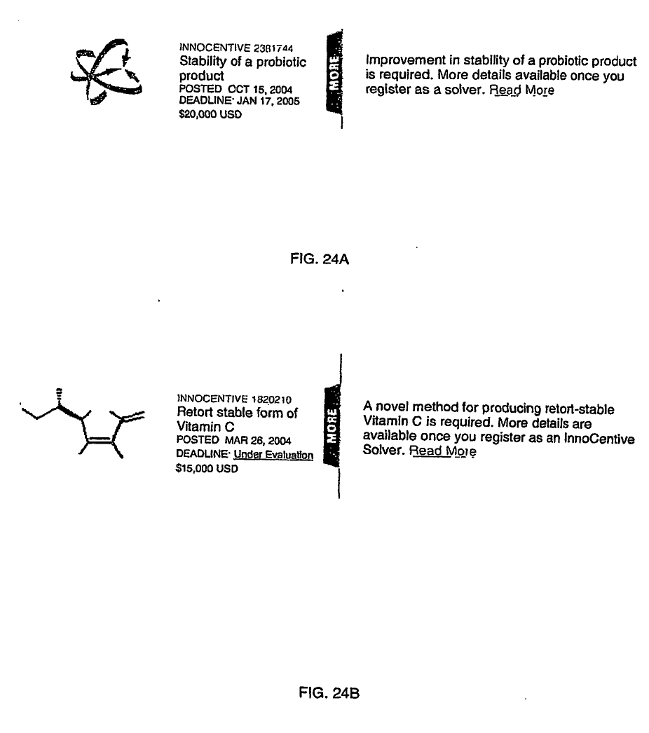

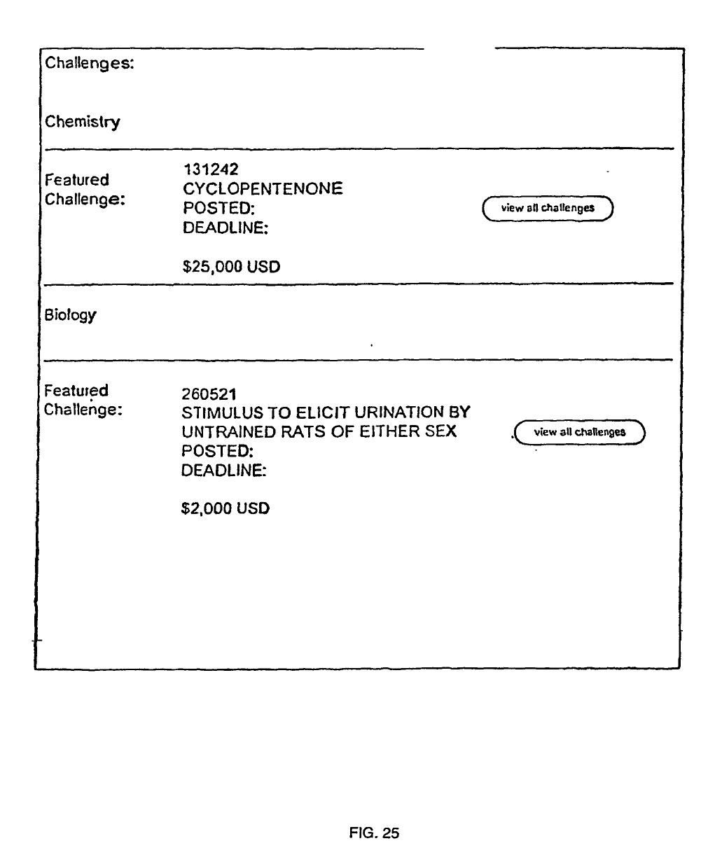

As illustrated in FIGS. 18 and 25, a user may view based on one or more categories, for example, subject matter, deadline, etc.

Clicking the “biology” button or the “chemistry” button may display a list of all current Challenges in that field.

According to another embodiment, as illustrated in FIG. 18, challenge processing system 151 may display all Challenges sorted, by example, by deadline, in descending order, with the graphic symbol and an abstract for the Challenge. This is referred to as the Abstract view. Using the dropdown lists at the top of the table, illustrated in FIG. 18, a user may restrict the view to challenges in a particular sub-specialty, change the sort field, or change the sort order. For instance, a user could restrict the view of chemistry Challenges to only those having to do with organic chemistry and sort them by award value. A user may also change the view from the Abstract view to a Summary view that shows the information about Challenges in a more concise text table.

To get more information about a particular challenge, in the Abstract view, illustrated in FIG. 12, a user may click on its graphic symbol or the vertical word “MORE.” In a view, illustrated in FIG. 18, a user may click on the Challenge ID #. This may bring the user to the Challenge Overview page. The graphic symbol for some Challenges may not be visible until the user signs the Solver Agreement. Then, the user may go to the Challenge Overview page, illustrated in FIG. 19.

As illustrated in FIG. 19, the Challenge Overview page may display an overview of the Challenge and provides a user with links to ask, for example, questions about the Challenge, email the Challenge to a friend, or start to work on the Challenge.

According to another embodiment, the invention provides features and functions for enabling a user or Solver to ask questions about a Challenge.

A user may click the “Ask a question about this Challenge” link, illustrated in FIG. 19, if the user wants to ask questions about the Challenge before he/she chooses to work on it. Questions are sent to intermediators, who may answer the user by email. No confidential or detailed information pertaining to the Challenge may be disclosed. The user may choose to work on the Challenge and sign the Solver Agreement to obtain this kind of information.

According to another embodiment, the invention provides features and functions for enabling a user to email a Challenge to other users or a friend.

A user may click the “Email this Challenge to a friend” link, illustrated in FIG. 19, if the user wants to email the Challenge to a friend or colleague. The user's friend may receive an e-mail with a brief description of the Challenge and a link to the Challenge Overview page for that Challenge. Clicking the link in the email may take him/her to a login/registration page which may include a brief description of the Challenge. Registering (or logging in, if the user's friend is already registered) may display the Challenge Overview page.

To view the detailed requirements of a challenge, a user may click the “Work on this Challenge” button, illustrated in FIG. 19. If the user has have already signed the Solver Agreement, a secure Project Room for this Challenge may be created for the user. If the user has not signed the agreement, the user may be presented with the Solver Agreement Confirmation page, where the user may review and, if the user agrees to its terms, accept the Solver Agreement.

According to another embodiment, the invention provides one or more agreements to a Solver.

In some embodiments, the Solver Agreement may be a non-disclosure/confidentiality agreement that also outlines the transfer of intellectual property rights to the Seeker Company for Solution proposals selected for an award. Before a user can work on a Challenge, the user may be required to accept the Solver Agreement. To read the Solver Agreement in a language other than English, select the language from the “Language” drop-down box (not otherwise illustrated in Figures). To print the Solver Agreement so a user can read it off-line, click your browser's “Print” button or select the “File—Print” command. To accept the agreement, a user can read through to the end and click the “ACCEPT” button. If the user does not agree to the terms of the agreement, the user may click the “DECLINE” button. In some embodiments, the user may still be able to view general information about Challenges posted on challenge processing system 151, but the user may not be permitted to see detailed information, including Challenge criteria, nor may the user be permitted to submit Solution proposals. Once the user has accepted the Solver agreement, the user can view detailed information about one or more Challenges and submit Solution proposals.

According to another embodiment, the invention provides a project room for users (e.g., Solver, intermediator, etc.) to work on a Challenge.

The Project Room is a secure and confidential area for a user to work on a selected Challenge. From the Project Room a user may review the Challenge details and Solution criteria, ask questions about the Challenge, receive answers from intermediators, and submit Solution proposal(s).

Before a user has committed to work on a Challenge, any questions the user asks may be through e-mail. When a user asks questions from his/her Project Room, they may appear in his/her Messages area. To ask a question, a user may click the “Messages” button, as illustrated in FIG. 21. The Messages area may display current messages the user has sent and the replies to them by the intermediators or other authorized access. A user can reply to an existing message or send a new one. The intermediators at challenge processing system 151 may be provided with a central Messages area to read and reply to the user's messages in a timely fashion. Messages may be displayed in descending date order, with the most recent messages on top. When a user responds to a message, the message the user responds to may not be included in the response. If a user desires, the user can have any messages he/she sends or receives in his/her Messages area. To do so, the user may check “email me when a new message is posted to this Message Center” checkbox before he/she sends the message. The forwarded message may include the text of the message as well as a link back to the Project Room.

There may be various types of Challenges. For example, Paper Challenges are theory based and may require a written Solution proposal with proper citing of references; whereas, Wet Challenges may require the submission of a sample of material as well as a written Solution proposal. Other types of Challenges may exist as would be apparent.

According to another aspect, the invention provides features and functions for submitting a Solution proposal.

A Solution proposal may describe a procedure developed by a user to solve a Challenge. Solution proposal files, which are secure and confidential, may be reviewed by intermediator or other authorized users and then forwarded to the Seeker Company that sponsored the Challenge.

According to the invention, solution proposals may be submitted as web or non-web documents.

In one embodiment, a user may click the “Submit a Solution” button in the Project Room for the Challenge for which the user is proposing a solution. The user may be taken to the Submission Process page, which provides detailed directions on how to submit a Solution proposal.

In the “Submit a Solution” section of the Submission Process page, as illustrated in FIG. 21, a user may click the “Browse” button to select one or more files on his/her computer that the user wants to submit. A copy of the file may be uploaded to the user's Project Room and may appear in a file list above the text field. The user may repeat this process for each additional file he/she wants to submit as part of the Solution proposal.

When files are added to the Project Room, a user may click the “Send” button (not otherwise illustrated in figures). This may send the user's Solution proposal file or files to intermediator B or other authorized users for review.

In some embodiments, after a user clicks the “Send” button, he/she may be presented with a confirmation screen. From this screen, a user may review the Solver Agreement, if desired. If the user is satisfied that the Solution proposal is complete and ready for review, the user may click the “Submit” button.

In some embodiments, when a user submits a Solution proposal, he/she may be returned to his/her Project Room. The Project Room may show the date the user submitted the Solution proposal.

A scientific team of intermediators or other authorized users may screen each Solution proposal to ensure that it satisfies the Challenge submission criteria. In some embodiments, if a Solution proposal does not seem to meet the criteria, a user/solver may receive an email from challenge processing system 151, outlines, for example, that the areas that need more work or clarification and asks the user/solver to resubmit the proposal after revisions. In some embodiments, solutions submitted to challenge processing system 151 may be forwarded to the Seeker Company—so even if the user/solver does not submit a revision, it will be reviewed by the Seeker Company.

In some embodiments, if a user's Solution proposal was not selected, the user may receive a detailed explanation from challenge processing system 151 of why his/her proposal was not chosen. If the user's Solution proposal is selected for an award by the Seeker Company, the user may be notified by challenge processing system 151. At that time, challenge processing system 151 may guide the user through a due diligence process. Once the user satisfactorily completes due diligence, the user may receive the cash award.

According to another aspect, the invention enables a system administrator to interact with the system and manage a information relating to system administration, Seekers, Solvers and Challenges.

In some embodiments, an Administrator (Admin) may have the highest level of access to challenge processing system 151. In some embodiments, Admins may access to any part of the system that an intermediator or Solver has. Admins typically are not scientists and concentrate primarily on performing system management tasks. An Admin's job may be to keep challenge processing system 151 running smoothly, maintain its integrity, and let the scientific team, intermediators or other authorized users, concentrate on the science part of their job.

Challenge processing system 151 may facilitate the ability for Admins to perform a plurality of tasks including, for example, providing administrative support to intermediators or other authorized users, answering Solver support messages, posting new Challenges, awarding and withdrawing Challenges, correcting posted Challenges, determining which Challenges are displayed in the Featured Challenges, creating and modifying Seeker Company, intermediator, and Admin accounts, removing and restoring privileges for Solvers, intermediators, or other Admins, sending announcements to Solvers, managing lists used internally by internal users of challenge processing system 151, handling system operations that cannot be managed automatically, evaluating survey results and other website usage data, etc.

If a Seeker Company decides to use resources associated with challenge processing system 151, it may sign a Seeker Agreement. Next, a scientist or intermediator of challenge processing system 151 may meet with the VP of R&D and scientists at the Seeker Company to review a pool of R&D problems that are candidates for Challenges and to go over the process of drafting Challenges. When a Seeker Company agrees to sign up with challenge processing system 151, it may contract to supply a specified number of problems for posting as Challenges over a specified time period. The benefits to the Seeker scientist may include: expanding their R&D capacity, allowing difficult problems to be introduced to a diverse audience of scientists, finding innovative approaches that lead to possible solutions, and moving to the next step or stage of R&D testing more quickly by outsourcing a part of the R&D process. Working with challenge processing system 151 may bring new ideas into the Seeker Company's R&D process, which the Seeker scientists may then use to further development of their projects. Handing off Challenges to challenge processing system 151 may also reduce the workload of Seeker scientists, enabling them to focus more attention on a smaller set of problems.

Once a Seeker Company identifies a Challenge it wants to post on challenge processing system 151, the Challenge drafting process begins. The Seeker Company scientist(s) involved with the problem and the intermediators with related background may work together to draft a description of the problem. Through multiple iterations of revision, the initial problem description may be distilled by the intermediators and the Seeker Company scientist(s) into the Abstract, Description, and Requirements that are posted to challenge processing system 151. This distillation process may require sending Challenge drafts back and forth several times, as well as numerous telephone discussions, before there is a final version ready for legal review by the Seeker Company. Challenge drafts and revisions may be, for example, written in Microsoft Word with embedded graphics and transmitted electronically.

Before a Challenge can be handed off to challenge processing system 151, it may be reviewed by the legal department at the Seeker Company. Legal review at the Seeker company is primarily aimed at protecting the Seeker Company's intellectual property, to make sure that there is nothing stated in the problem that could identify the Seeker Company or that might release proprietary information. If the Seeker Company's legal department signs off on a Challenge, the problem may be reviewed by the intermediators and sent to challenge processing system 151 as a pending Challenge. If the Seeker Company's legal department requires changes in the way the Challenge is worded, then the distillation process may continue until either a Challenge draft that is satisfactory to the Seeker Company is developed or the Seeker Company decides not to post the Challenge.

When the intermediator sends the completed Challenge to the Admin, he/she may specify who the Seeker Company is, the award amount, the details of the problem, and what disciplines to categorize the problem under. The intermediator may supply a document and any additional graphics. The Admin may then post the Challenge to challenge processing system 151 with a status of Pending.

The intermediators may review the pending Challenge. If there are errors in the Challenge, the intermediator may either correct the errors or notify the Admin. Once the Challenge is in its proper form, the intermediator may change the status from Pending to Open, causing it to appear on an internet or intranet of the invention as a posted Challenge.

According to another embodiment, the invention provides features and functions for facilitating communications among Admins, Solvers, intermediators, and Seeker Companies.

Admins typically do not communicate directly with Solvers or Seeker Companies about issues related to Challenges. Their communication may be limited to working with the intermediators or scientific teams on administrative and support issues.

Some of their support tasks are routine, such as resending a verification email. When required, they may also handle Solver problems that cannot otherwise be performed automatically, or that the Solver has trouble performing (for example, entering Solution proposals that have been received by fax or mail into the system, where they can subsequently be tracked by intermediators).

Contact between Admins and Seeker Companies may be done through administrative requests made by intermediators during the period in which Challenges are being developed and posted.

According to another embodiment, the invention provides features and functions for awarding a Challenge.

In some embodiments, awarding a Challenge may include awarding the Solver and awarding the Challenge, itself. The result of awarding the Solver may be that the Solver receives the cash incentive. The result of awarding the Challenge may be that the Challenge appears in the Awarded Challenges section of challenge processing system 151 and the Project Rooms for the Challenge.

In some embodiments, the Challenge, itself, may not be awarded until all Solvers who submitted Solution proposals for that Challenge have been notified either that their proposal was selected or rejected. To award a Challenge after all the Solvers who have submitted Solution proposals for that Challenge have been notified, a user may: go to the Challenge Overview page; in the Administration area, change the status of the Challenge to Awarded; click the “Continue” button to make the change.

In the Challenge Overview page, the status of the Challenge may change to Awarded. In some embodiments, objects linked to the challenge may also be changed to Awarded.

In some embodiments, awarding a Challenge may also list the awarded Challenge on the Awarded Challenges page, close all Submitted and Open Project Rooms for that Challenge except for the Project Room for the Solver(s) who received the award, cause an email to go out to all Solvers who have opened Project Rooms for this Challenge informing them that their Project Room has been closed, prevent new Project Rooms for this Challenge from being opened, change the status of other submitted Solution proposals for this Challenge to Declined, list the Challenge as Awarded in the Project Room for the awarded Solver(s) in the Past Challenges area of the Solver(s)' My Challenge page, list the Challenge in the Awarded Challenges area of the Challenges page for the Seeker Company, and/or remove the Challenge from the “Submission Tracking” table.

According to another embodiment, the invention provides features and functions for withdrawing a Challenge.

A Challenge may be Withdrawn at the discretion of the Seeker Company. For example, the Challenge may be Withdrawn because the deadline has passed and the Seeker Company has not received any Solution proposals it wants to award; because the Seeker Company has found a solution in-house; because a solution is no longer required; or because the Seeker Company is not satisfied with the rate at which Solution proposals are coming in. In any of these events, the Admin may change the status of the Challenge to Withdrawn by clicking, for example, the “Seeker Summary Report” tab to display the table of Seeker Companies, clicking the username of the Seeker Company whose Challenge the Admin wants to withdraw, clicking the number of the Challenge, to go to the Challenge Overview page, changing the status of the Challenge to Withdrawn in the Administration area, and clicking the “Continue” button to make the change.

The status of the Challenge changes to Withdrawn.

In addition to changing the status of the Challenge in the Challenge Overview to Withdrawn, withdrawing the Challenge may close all Submitted and Open Project Rooms for that Challenge, prevent new Project Rooms for this Challenge from being opened, remove the Challenge from the list of posted Challenges, list the Challenge in the Withdrawn Challenges area of the Challenges page for the Seeker Company, remove the Challenge from the “Submission Tracking” table and updates any submitted Solution proposals to Declined, and send a message to Solvers who have open Project Rooms telling them that the Challenge has been withdrawn.

According to another embodiment, the invention provides features and functions for tracking Solution proposals.

When Solvers submit Solution proposals, they may receive an automated response thanking them for their submission. An email may also be automatically sent to the email account that is used by all intermediators as part of the submission tracking process. In addition, the new Solution proposals appear in the “Submission Tracking” tab of the my intermediators page with a status of “Submitted.” Each Solution proposal may be reviewed by an intermediator who is familiar with the scientific area of the proposal to determine whether it meets the Seeker Company's criteria. The intermediator may be able to determine this without additional consultation, or he/she may need to consult the Seeker scientist who is involved in the Challenge. In some embodiments, if the Solution proposal does not meet the criteria specified in the Challenge, the intermediator may contact the Solver to describe the issues and encourage the Solver to either rectify the problems in his/her proposal or submit a new proposal.

Once a Solution proposal has been reviewed by the intermediator, the intermediator may continue to track the proposal until it is either awarded or not selected to receive an award. The primary tool for tracking submissions is the “Submission Tracking” table of the “My Challenge” page illustrated in FIG. 20. Both Admins and intermediators can also view information on Challenges associated with each Seeker Company via the “Seeker Summary Report.”

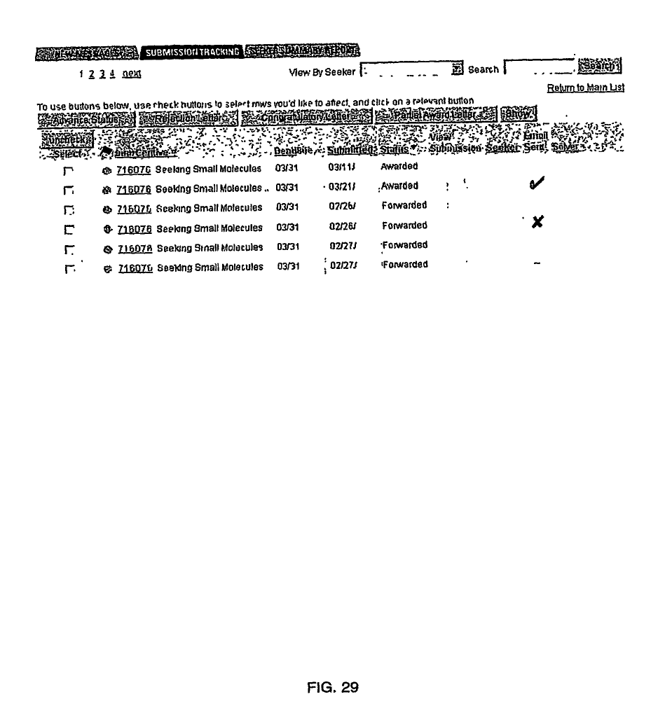

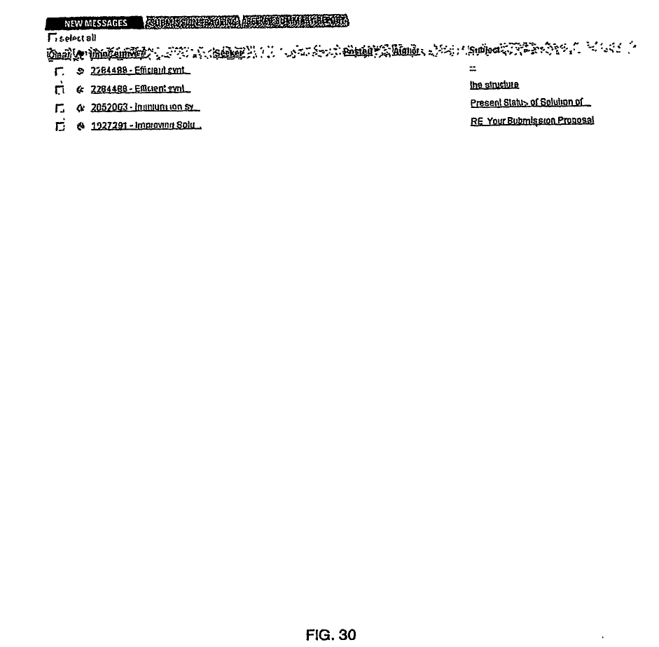

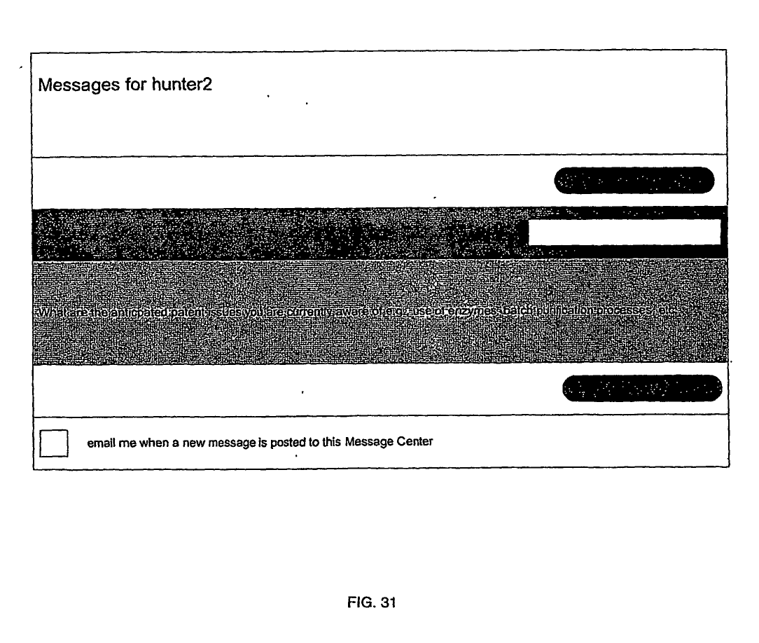

The “Submission Tracking” tab, illustrated in FIG. 29, is designed to advance a Solution proposal from Submitted to Awarded. In some embodiments, the Declined status may be automatically assigned to Declined by actions taken by the Admin upon either Awarding or Withdrawing the Challenge.

According to the invention, when a Challenge is awarded, the Project Rooms for all the other Solvers who have worked on this Challenge are automatically closed. The status of Solution proposals submitted for this Challenge may also automatically advance to Declined in the “Submission Tracking” tab.

According to the invention, when a Solution proposal has been selected for an award but the Solver either turns down the award or does not pass the due diligence process, his/her Project Room may be closed and the status of his/her Solution proposal may automatically advance to Declined in the “Submission Tracking” tab.

According to another embodiment, the invention provides features and functions for personalizing a Project Room for an Admin for managing one or more Challenges or one or more portfolios of Challenges for a Seeker, a Solver, etc.

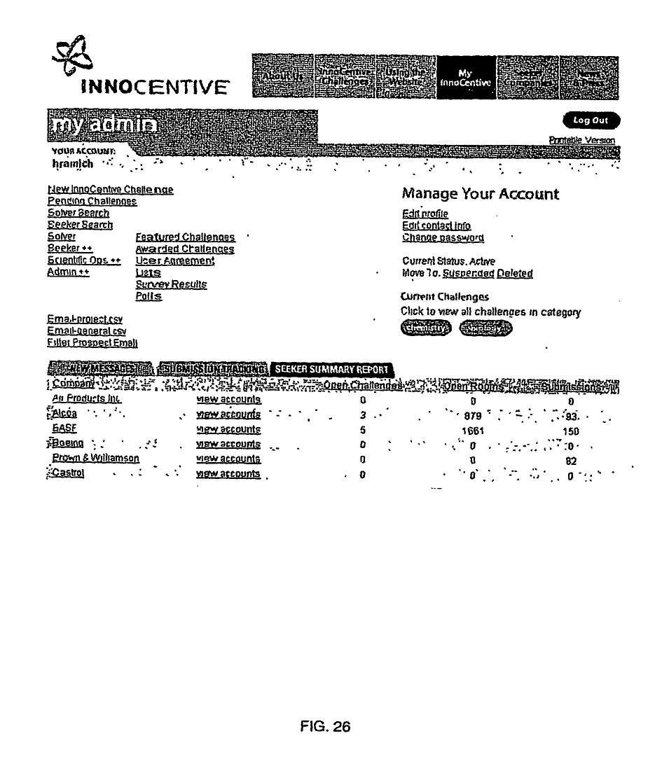

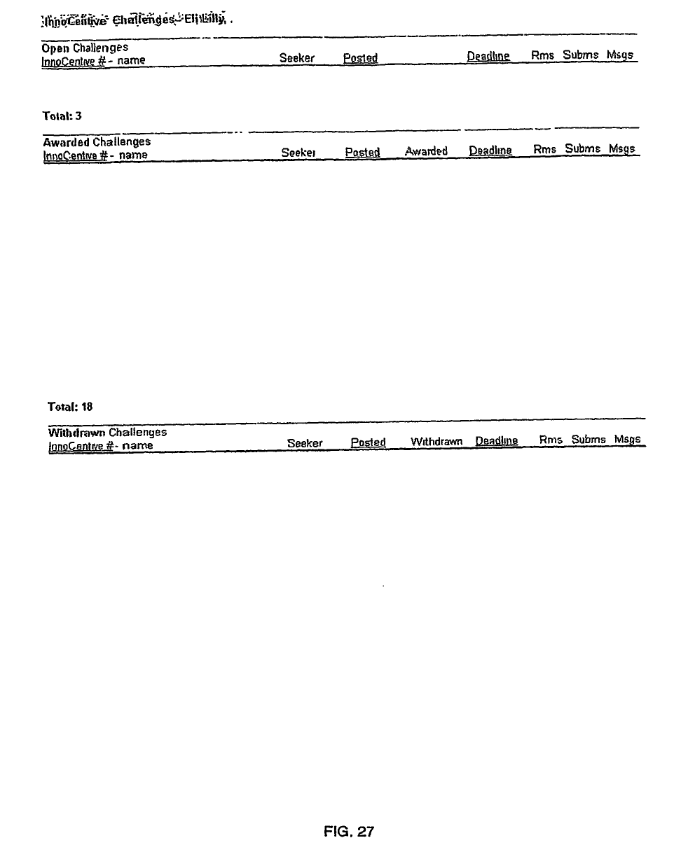

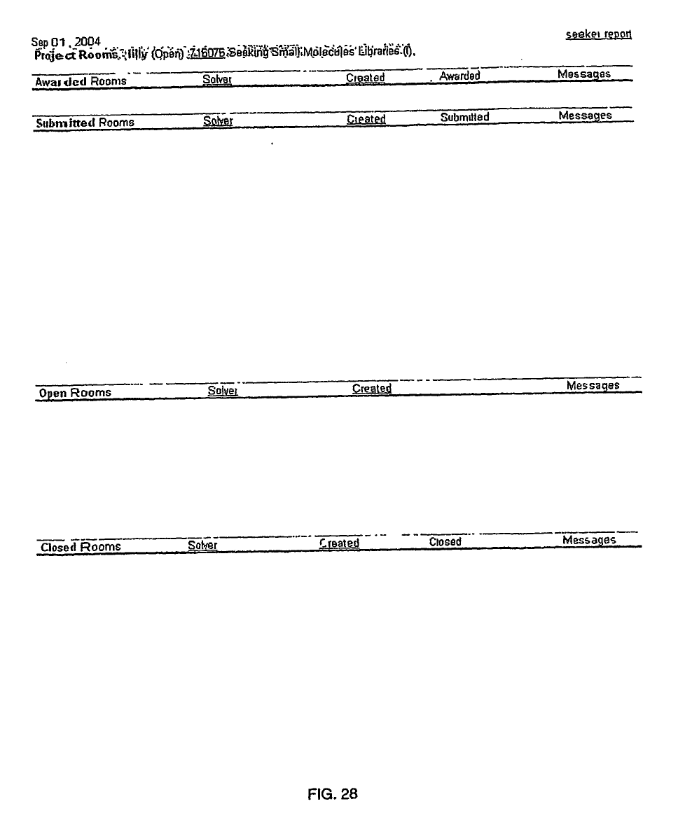

In some embodiments, the hub of the Admin's work with the website may be his/her my admin page. In some embodiments, Admins may automatically be routed to this page when they log in or when they click the “My Admin” tab. The my admin page may open with the Seeker Summary Report tab selected. Typically, Admins spend most of their day-to-day work with the system posting new Challenges, handling support issues, and changing the status of posted Challenges. “My Admin” page, illustrated in FIG. 26, may include features and functions for facilitating the ability for Admins to create new Challenges, edit and post Pending Challenges, search for Solvers by username, email address, name, or country, create new Seeker Company, intermediator, or Admin accounts, change the status of a Solver, intermediator, Admin, or Seeker Company account, view reports on Challenges, organized by Seeker Company, send announcements to Solvers, change the Challenges shown as Featured Challenges, Featured Awarded Challenges, manage lists used internally by the internet or intranet of the invention, view and evaluate survey results, view, edit, and change the status of current Challenges, track and change the status of Solution proposals, communicate with Solvers about Challenges, manage their own accounts, etc.

According to another embodiment, the invention includes features and functions for providing a Seeker Summary Report.

The “Seeker Summary Report” tab may display a table of Seeker Company accounts, as illustrated in FIG. 26. The table may show the Account Name of each Seeker Company, the company's actual name, the number of open Project Rooms for each company, and the number of Solution proposal submissions.

In one embodiment, clicking the Account Name of a Seeker Company may display, for example, a table of Open, Awarded, and Withdrawn Challenges for that company. Each segment of the table can be sorted by Challenge ID #, by the date the Challenge was posted, or by the Challenge deadline date. In the Deadline column, challenges in indicator text (e.g., colored text) are those whose deadline has passed.

In another embodiment, clicking a Challenge number may display, for example, a table of Awarded Project Rooms, Submitted Project Rooms, Open Project Rooms, and Closed Project Rooms (if any exist) for that Challenge. Each column can be sorted by Solver or Project Room creation date.

In another embodiment, clicking the Solver name may display the Solver's Project Room. Unlike the Solver's view of the Project Room, the Admin view of the Project Room may include, for example, an Administration area which allows a user to change the status of the room. Changing the status of a Project Room using the “Seeker Summary Report” tab may be done when some aspect of the submission can't be handled through the “Submission Tracking” tab. For instance, if a Solver mails or faxes his/her Solution proposal to challenge processing system 151 instead of submitting it electronically, an Admin may either convert the proposal to electronic form and upload it from the Solver's Project Room or may manually enter the proposal into the system as a Submitted proposal. From that point on, the status would be tracked and changed through the “Submission Tracking” tab. In addition, if a Solver declines an award, or the Solver does not pass the due diligence process, an Admin may close the Solver's Project Room and the Solution proposal status may change to Declined.

According to another embodiment, the invention includes features and functions for tracking submissions.

Tracking of Solution proposals takes place primarily through the “Submission Tracking” tab, illustrated in FIG. 29.

Clicking the “Submission Tracking” tab may display a list of current Solution proposals. This list can be sorted by Challenge number, Challenge deadline, proposal submission date, proposal status, Solver, or Seeker Company.

The status of a Solution proposal always advances only one step at a time (linearly) from Submitted. The solution statuses are: Submitted, Reviewed, Forwarded, Selected, Due Diligence, and Awarded. To advance the status of a single proposal, a user may click the “(advance)” link next to the current status, as illustrated in FIG. 29. To advance a group of Solution proposals, a user may check the checkbox under the “Advance status” button for each proposal you want to advance and then press the “Advance status” button, as illustrated in FIG. 29.

The header fields for the “Submission Tracking” table are illustrated in FIG. 29.

Advance status may allow a user to advance the status of one or more Solution proposals by checking a checkbox and clicking the “Advance status” button. All proposals advanced in this manner may be at the same status.

According to one embodiment, solution proposals may be automatically granted Submitted status when the Solver submits them.

According to another embodiment, Solution proposals may be given Reviewed status when they are in the internal review process. This may be a relatively basic review of the proposal. Intermediators or other authorized users may give feedback to Solvers on ways their proposal might be improved. During the Reviewed phase, the intermediator may encourage the Solver to revise the proposal or to submit a new one. Once the intermediator has reviewed the Solution proposal, he/she may send it to the Seeker Company for review. In some embodiments, Solution proposals may be treated by challenge processing system 151 as a new proposal, so that the Seeker Company has an opportunity, for example, to review the Solver's thinking at various stages of development. In some embodiments, a Seeker Company might look at multiple proposals by the same Solver and invite the Solver, through the intermediator, to try a new proposal that combines innovative elements from several previously submitted proposals.

According to another embodiment, the status of a Solution proposal may be advanced to Forwarded after the proposal has been sent to the Seeker Company for review. Solution proposals for paper challenges may be sent electronically. Solution proposals for wet Challenges may include a written summary sent electronically and samples sent by a parcel service such as Federal Express. The date, relative to the Challenge deadline, that a Solution proposal is sent to a Seeker Company may depend on the Seeker Company. Some Seeker Companies may ask to receive proposals as soon as they are submitted; others may wait until a few days before the deadline date (and then again after the deadline date) to receive batches of Solution proposals; while others may wait until the deadline date has passed to receive all proposals.

Selected Solution proposals are proposals the Seeker Company has chosen for the award. The Challenge may remain open until the Solver has successfully completed due diligence and the Solvers whose proposals have been rejected have been notified.

After the Seeker Company has selected a Solution proposal, the Solution proposal's status may be advanced to Due Diligence. Typically, the intermediator may send an email to the Solver congratulating him/her on being selected and informing him/her that a due diligence process must be completed before the Seeker Company can issue the award. During this phase, challenge processing system 151 may verify who the Solver is, have him/her sign a physical copy of an affidavit that confirms the Solver Agreement, verify that the Solver is willing and able to sign over the intellectual property for the Solution, and if necessary obtain a waiver of the Solver's Employment Agreement with his/her employer for the intellectual property rights to the Solution. If the Solver does not meet the due diligence requirements, he/she may no receive the award. Once the Solver passes due diligence, the status of the Solution proposal may be advanced to Awarded. If the Solver does not meet the due diligence requirements, the Solution proposal status may be changed by the Admin to Declined and the Solver's Project Room may be closed. The Declined status may be automatically reflected in the “Submission Tracking” table.

According to another embodiment, once the Solver has successfully completed due diligence, the intermediator or Admin may advance the proposal status to Awarded and the Solver may be paid the financial incentive. The intermediator may notify all the other Solvers who submitted Solution proposals that their proposals have not been selected. The intermediator may get feedback from Seeker Company scientists on why Solution proposals were declined. A Solution proposal may be technically correct, but the approach may not be sufficiently novel, or may be too expensive, or may be too similar to a solution already in-house. The intermediator may write a personalized letter of explanation to each Solver whose proposal was rejected explaining the reasons for the rejection. When the Solvers who submitted Solution proposals to the Challenge have all been notified, the Admin may post the Awarded Solution to the website and close all the Project Rooms for this Challenge. Posting to the website typically happens 14-60 days after the award has been made, to ensure that all the other Solvers who submitted Solution proposals for the Challenge have been notified that their proposals were rejected.

According to another embodiment, the invention includes features and functions for providing details of one or more submissions.

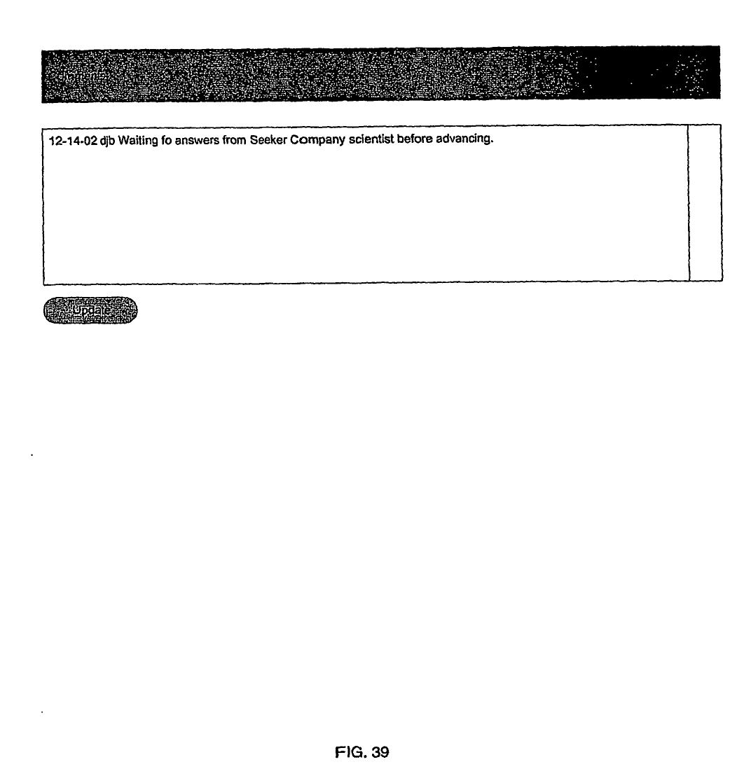

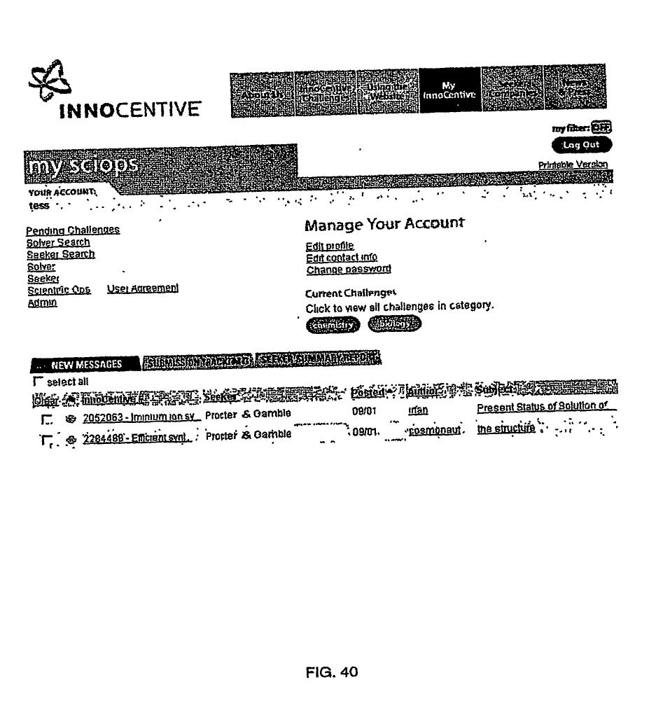

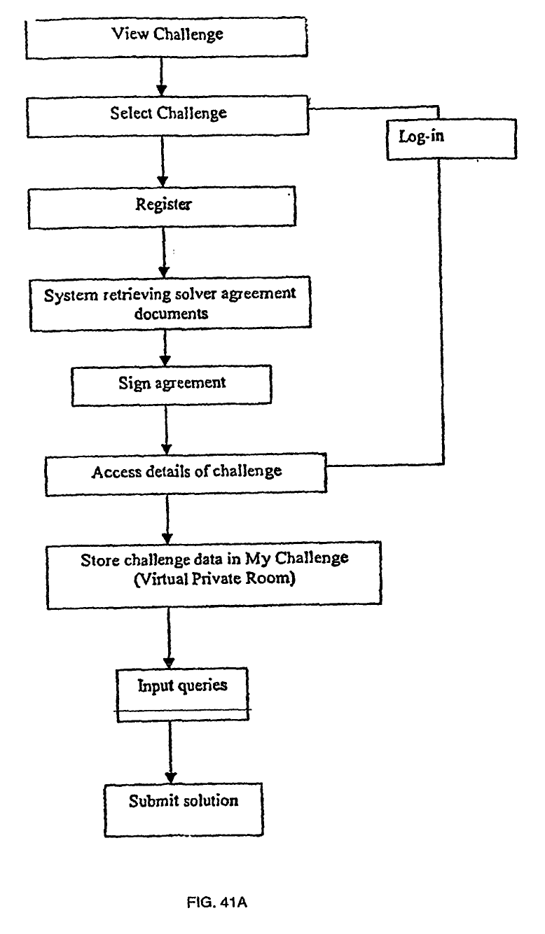

According to another embodiment, clicking the “Proposal” link for a specific Solver's Solution proposal displays the Submission Details page for that proposal. From this page, a user can view details of the Challenge, change the status of the Challenge, review the Solution proposal, make comments on the proposal to be viewed by other intermediators or Admins, and view the history of changes to the proposal's status. In one embodiment, the Submission Details pages are viewed and modified by intermediators. In some embodiments, a user can write comments on the proposal, either for him/herself or for other intermediators or Admins, in the text box labeled “Comments,” as illustrated in FIG. 39. Comments may be dated and initialed. More recent comments may go at the top. A user may click the “Update” button to save any changes or comments. Scroll bars may appear in the “Comments” text box when the amount of text exceeds the size of the box.

According to another embodiment, clicking the “Subject” link for a particular message may display a new page which may include the current message as well as any previous messages and replies for a Project Room. There, a user can view the messages pertaining to that Project Room, reply to a message, or send a new message to the owner of the Project Room. Once submitted, the message may appear in the Messages area of the Solver's Project Room for that Challenge. If the Solver has asked that messages be forwarded to him/her, then a copy of the message may be also emailed to the Solver. In some embodiments, solvers may return to their Project Room to add a reply or send a new message.

According to another embodiment, the invention may include a “New Challenge” link, as illustrated in FIG. 26.

The “New Challenge” link may permit a user to enter a new Challenge into challenge processing system 151. The new Challenge may appear in the Pending Challenges list until it is reviewed by an intermediator and then posted either by an Admin or by the intermediator. In some embodiments, when an intermediator and Seeker Company scientist come to an agreement on the wording of a new Challenge and the legal department at the Seeker Company has approved the Challenge for posting, the intermediator may pass the Challenge on to an Admin for posting on the website. At this point, the Challenge may be in a document that provides the abstract, description, detailed description and requirements, and criteria In some embodiments, an image may also be embedded in the document.

The intermediator may also supply the Admin with the name of the Seeker Company, the Challenge deadline, the award amount, whether to show the image (if any) in the Abstract view of the Challenge, the scientific discipline(s) under which to list the Challenge, etc.

According to another embodiment, the invention may include features and functions for viewing Challenges.

Challenges may be viewed based on plurality of categories and subcategories. As illustrated in FIG. 26, clicking either the “chemistry” or the “biology” button in the “Current Challenges” section (not otherwise illustrated in FIG. 26) of my admin page may display a list of the current chemistry or biology Challenges.

A user may view a subset of the Challenges by choosing a sub-discipline from the “View By Category” dropdown list, illustrated in FIG. 18.

A user may sort the Challenges list by deadline in either descending or ascending order. In some embodiments, the Challenges list defaults to showing the Abstract view, which includes the graphic symbol for the molecule, if any, and a short description of the Challenge.

A user may also see a Summary view, which shows only the Challenge ID #, name, posted date, deadline, and award in table form. A user may toggle between these two views by clicking the “SUMMARY VIEW” and “ABSTRACT VIEW” tabs.

To view or edit a Challenge, a user may click a graphic symbol or a vertical text (e.g., “MORE”), if the user is in the Abstract view or click the Challenge ID # if the user is in the Summary view.

A user may view or review a detailed description, edit the Challenge information, and change the image.

Admins may copy the abstract, description, and criteria of Challenges that they receive from intermediators into the proper fields and may add formatting (such as bold, bullet points, etc.). Challenge processing system 151 may generate the Challenge to display on a website. Admins may also receive from intermediators information about how to categorize the Challenge. In addition, they can upload and/or update images, for example, the NMR (Nuclear Magnetic Resonance Spectroscopy) data, and the IR (Infrared Spectroscopy) data. Spectral data may come in any of several formats known to one skilled in the art.

By default, the Challenge Overview page, illustrated in FIG. 19, may display the text of the Project Overview. To review the Detailed Description & Requirements, a user may click the “View Detailed Description” link. If there are problems with the way either the Project Overview or the Detailed Description & Requirements read, or if their formatting is incorrect, a user may correct them by clicking the “Edit Info” link (illustrated in FIG. 26).

According to another embodiment, the invention provides features and functions for editing Challenge information.

As illustrated in FIG. 26, to edit the information in the Challenge, a user may click the “Edit Info” link to go to the Edit a Challenge page. This page may display, for example, the name of the Seeker Company, the name of the Challenge, the Challenge deadline, the award amount, and the Abstract, Summary, Description, and Criteria of the Challenge. This page may also include a checkbox that determines whether the image can be viewed from the list of Challenges or only from a Solver's Project Room. In addition, this page may include a plurality of checkboxes that identify the disciplines under which this Challenge should be classified. The Seeker name may be selected from a dropdown list of Seeker Company usernames. Tables, lists, symbols and/or references to images or files may be formatted, as would be apparent. The user may then click the “Save” button at the bottom of the page to save changes.

According to the invention, to change an experimental data, for example, spectral data, a user may click the “Change Spectral Data” link (not otherwise illustrated in figures) to go to the Spectral Data Upload page.

To upload new data, for example, IR data or NMR data, a user may click the appropriate radio button, then click the “Browse” button to browse for the file that contains the updated data. The user may select the file he/she wants to upload and click the “Open” button. When the path and filename appear in the text area beside the “Browse” button, the user may click the “upload” button to upload the data.

According to the invention, to change the image associated with a Challenge, for example, molecular structure image, a user may click the “Change Image” link (not otherwise illustrated in figures) to go to the Image Upload page. From here, the user can upload a new image for the molecular symbol or reset the image to the default image. In some embodiments, to reset the image to the default, the user may click the “reset to default image” link. To upload a new image file, the user may click the “Browse” button to browse for the file that includes the updated image. The user may select the file he/she wants to upload and click the “Open” button. When the path and filename appear in the text area beside the “Browse” button, the user may click the “Upload” button to upload the new image.

According to the invention, clicking the “Pending Challenges” link on the “My Admin” page (illustrated in FIG. 26) may take a user to the Pending Challenges page. This page may include a list of Challenges which have been developed by the intermediator and Seeker scientists and have been created as Challenges by an Admin, but have not had final review by the intermediators and have not been made visible to Solvers. They may be posted by either an intermediator or an Admin after the intermediator has reviewed them. While Challenges are in the Pending state, intermediators may make edits themselves or they may inform the Admin of any needed changes.

To make changes to a Pending Challenge, a user may, for example, click the vertical word “MORE” or the image (e.g., molecular structure image) for the Challenge (illustrated in FIGS. 17, 24A and 24B). Clicking either place may bring the user to the Challenge Overview for that Challenge, where the user may make changes.

After the intermediator reviews the final wording and appearance of the Challenge, the intermediator or Admin may change the status from Pending to Open. At this point, a notification email may go out to Solvers who have indicated an interest in the scientific discipline(s) where the Challenge falls.

To change the status of a Challenge from Pending to Open, a user may check the checkbox next to the name of the Challenge and click the “Post selected challenges” button. A user can change the status of multiple Pending Challenges to Open by checking the checkbox for each challenge he/she wants to post and then clicking the “Post selected challenges” button. In some embodiments, if the user posts multiple Pending Challenges at once, the email that goes to potentially interested Solvers may consolidate posted Challenges into a single message.

According to another embodiment, the invention provides links to “Featured Challenges.”

A user may click the “Featured Challenges” link that may take the user to the Featured Challenges page, illustrated in FIGS. 24A and 24B. This page may allow the user to select the Challenges displayed on a website.

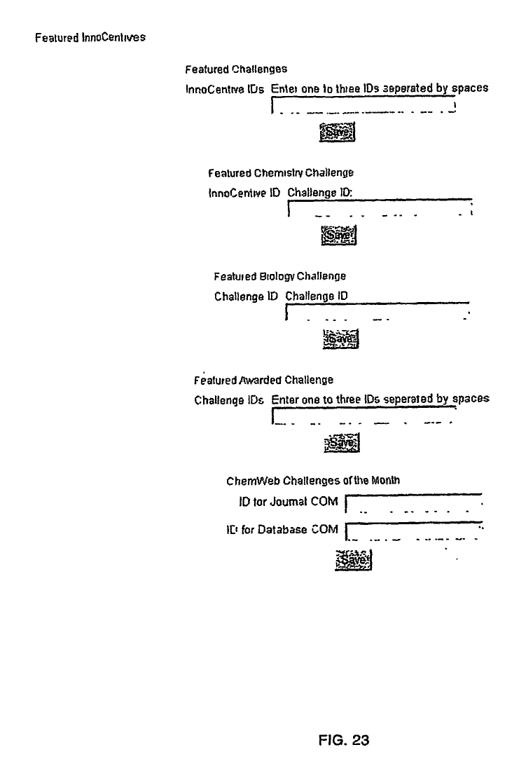

A user may enter one or more Challenge IDs separated by spaces and click the Save box, as illustrated in FIG. 23. These Challenges may appear on the “Featured Challenges” section of the website.

The invention provides features and functions for creating featured challenges based on one or more criteria, for example, subject matters (e.g., Featured Chemistry Challenge, featured Biology Challenge, etc.) A user may specify one or more websites for displaying the selected featured Challenges.

According to another embodiment, the invention provides lists for Challenge-related data.

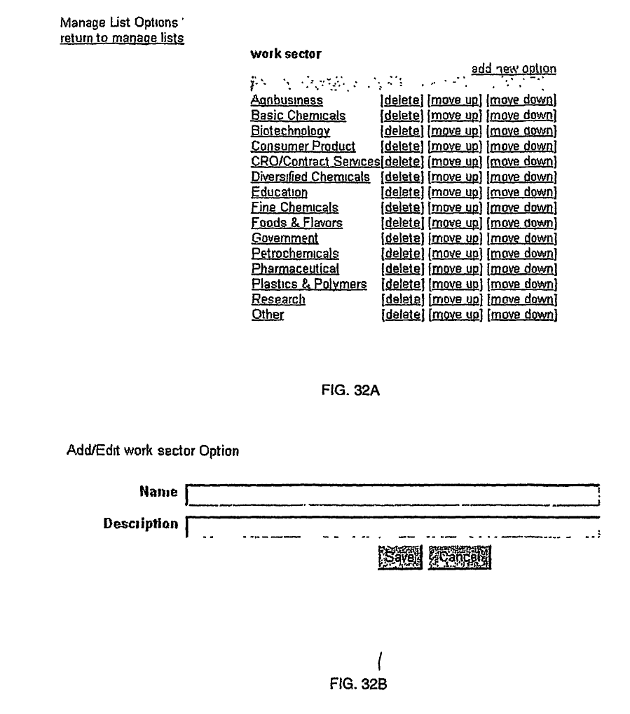

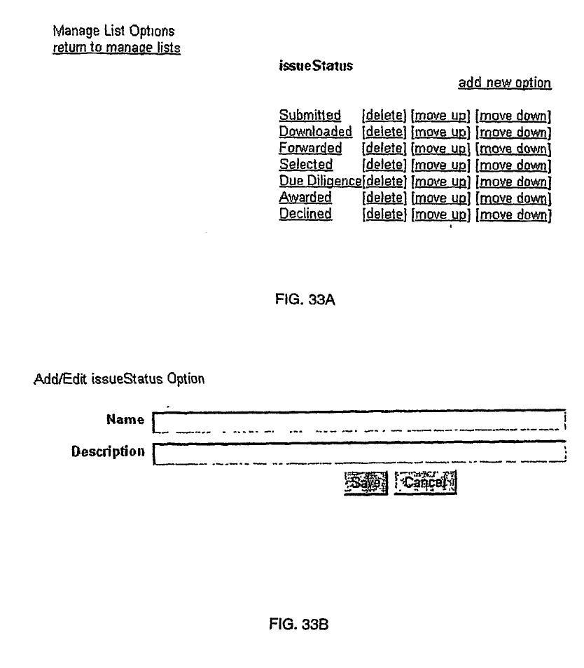

According to the invention, clicking the “Lists” link may take a user to the Manage Lists page, illustrated in FIGS. 32A, 33A and 34. The manage lists page may allow a user to change or add values to the lists used by various parts of challenge processing system 151.

The Manage Lists functions may enable a user to change the name of a list, change the contents of a list, delete a list, and create a new list.

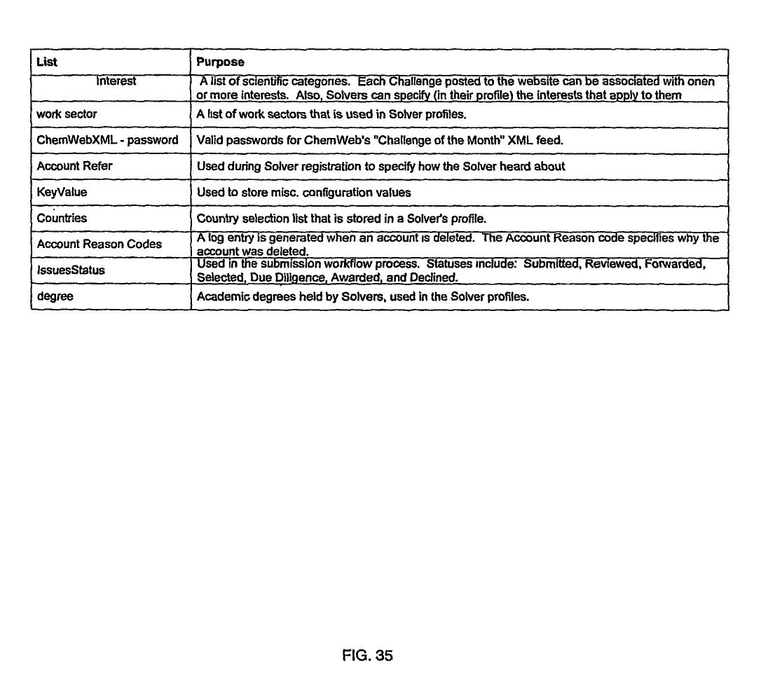

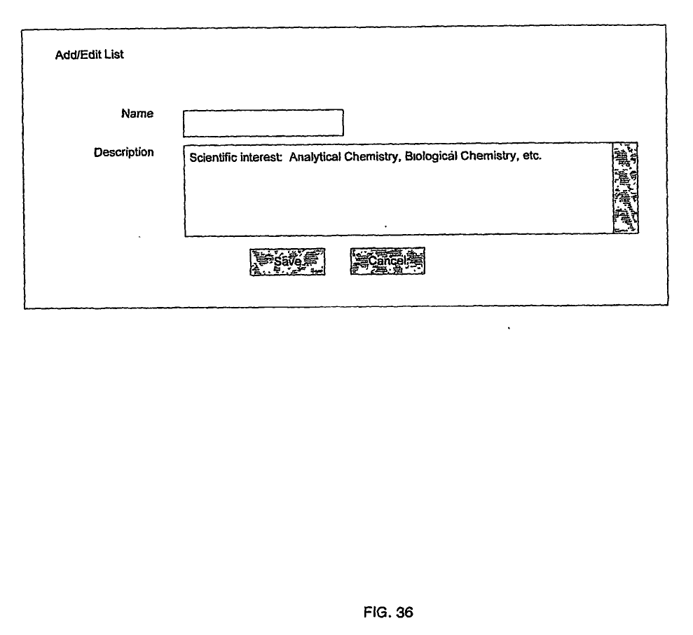

As illustrated in FIG. 35, each Challenge posted to the website can be associated with one or more interests. Also, Solvers can specify (in their profile) the interests that apply to them. Challenge processing system 151 may include a plurality of lists, for example:

work sector—a list of work sectors that is used in Solver profiles;

WebXML—password Valid passwords for Web's “Challenge of the Month” XML feed,

Account Refer—used during Solver registration to specify how the Solver heard about system 151.

KeyValue—Used to store misc. configuration values,

Countries—Country selection list that is stored in a Solver's profile,

Account Reason Codes—A log entry is generated when an account is deleted,

IssueStatus—Used in the submission workflow process (Statuses include: Submitted, Reviewed, Forwarded, Selected, Due Diligence, Awarded, and Declined).

degree—Academic degrees held by Solvers, used in the Solver profiles, etc.

According to the invention, to change the name of a list, a user may click the name of the list in the Manage Lists page, illustrated in FIG. 32A. This may take the user to the Add/Edit List page for that list, illustrated in FIG. 32B. For all lists except the IssueStatus list, the “Name” field determines the name listed in the Manage Lists page and the “Description” field is used only to identify the contents of the list for administrators.

To change the contents of a list, a user may click the “add/edit option” link adjacent to the list name. This may take the user to the Manage List Options page for that list. From this page, the user can change the order of the list elements, delete a list element, or add a new list element.

To move a list element up or down, a user may click the “move up” or “move down” links.

To delete a list element, a user may click the “delete” link.

To add a new list element, a user may click the “add new option” link. This may take the user to the Add/Edit Option page for that list. The user can enter the name and description of the new list element here.

To change a list element, a user may click the name of the list element. This takes the user to the Add/Edit Option page for that list. The user can change the name and description of the new list element here.

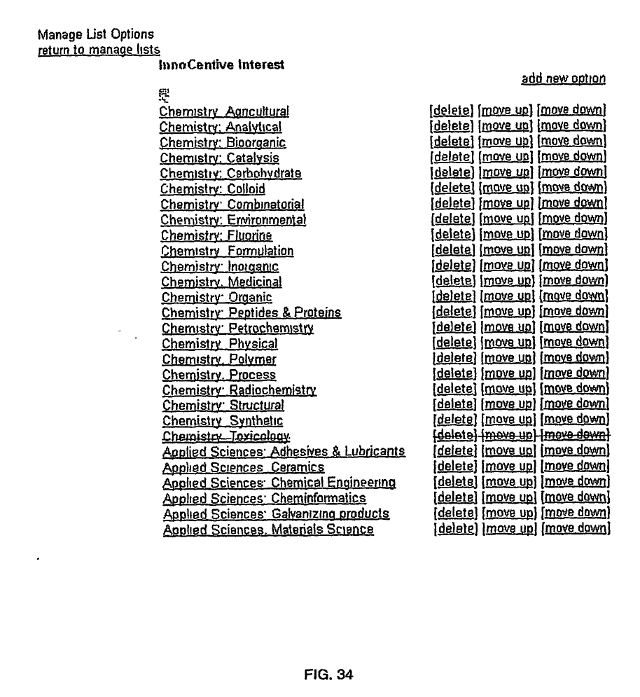

As illustrated in FIG. 34, the Interest list may determine the content and order of the scientific areas displayed in the Edit a Challenge page for all Challenges and in the scientific interests area on the Solver registration form. The format for the “Name” field for these list elements may be, for example, “Field: Specialty,” as in “Chemistry: Agricultural.” When a user adds a new option, it may not be automatically alphabetized. A user may use the “move down” or “move up” links to move a new list element to its appropriate location.

According to another embodiment, the invention provides features and functions for searching Solvers or Solver-related information.

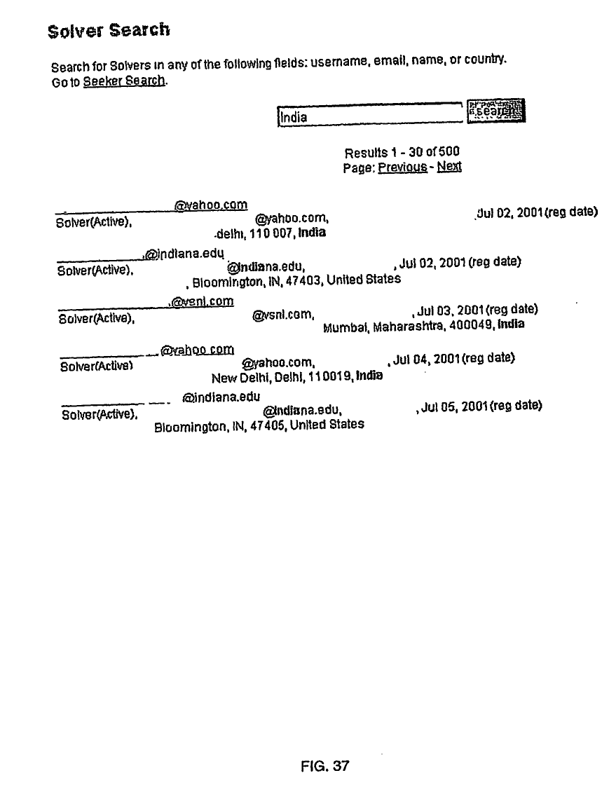

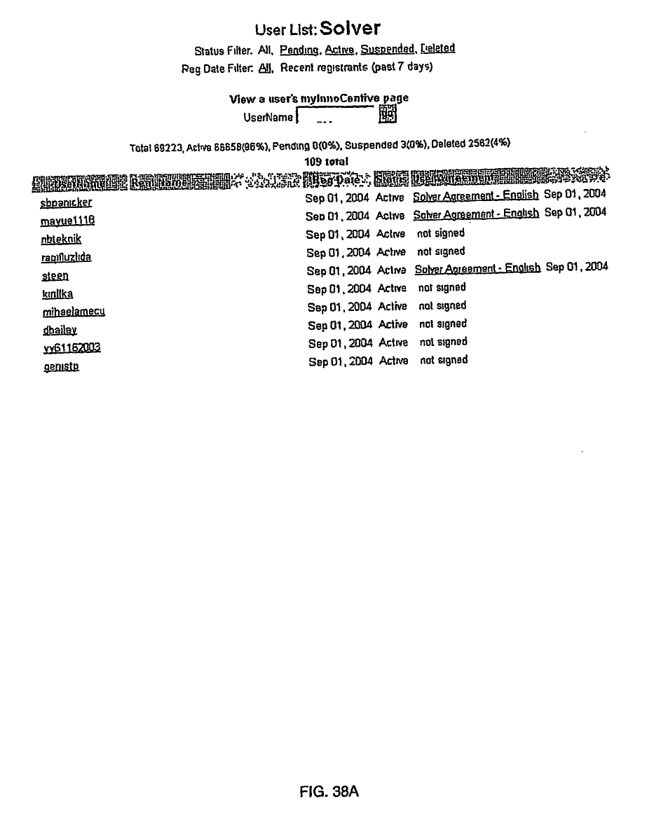

As illustrated in FIG. 37, the “Solver Search” link may take a user to the User Search page, where a user can search for a Solver (or any other user) by username, email address, name, or country. The user may enter the search information in the text area and click the “search” button. If there is only one Solver who matches the search criteria, the user may be taken to the User Information page for that Solver, which may display the information the Solver entered when he/she set up a profile. It may also include links to the Solver's My Challenge page and the Solver Agreement he/she signed. In addition, it may include links that enable the user to edit the Solver's profile and contact information, reset his/her password, and resend the Solver verification email.

If more than one Solver matches the search criteria, then a list of Solvers may be displayed after the user clicks the “search” button. The list may include a brief summary of the information on each Solver's User Information page.

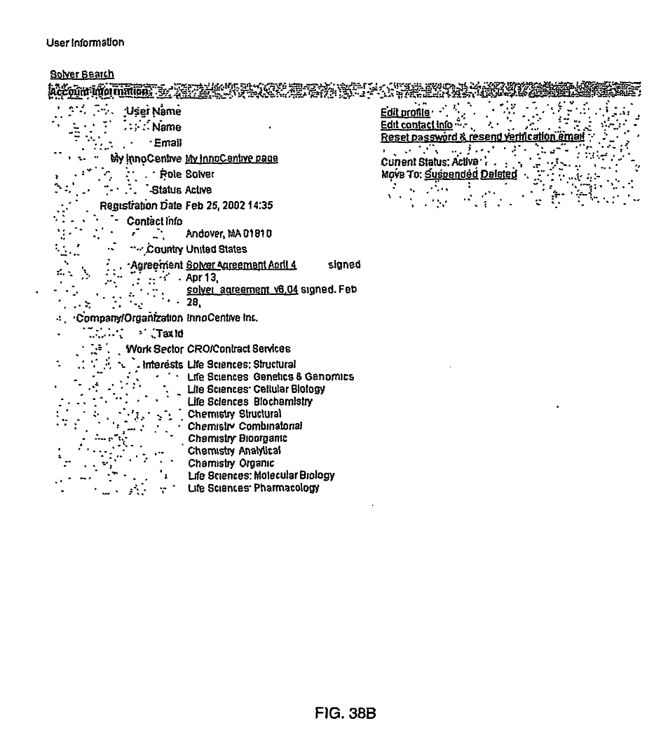

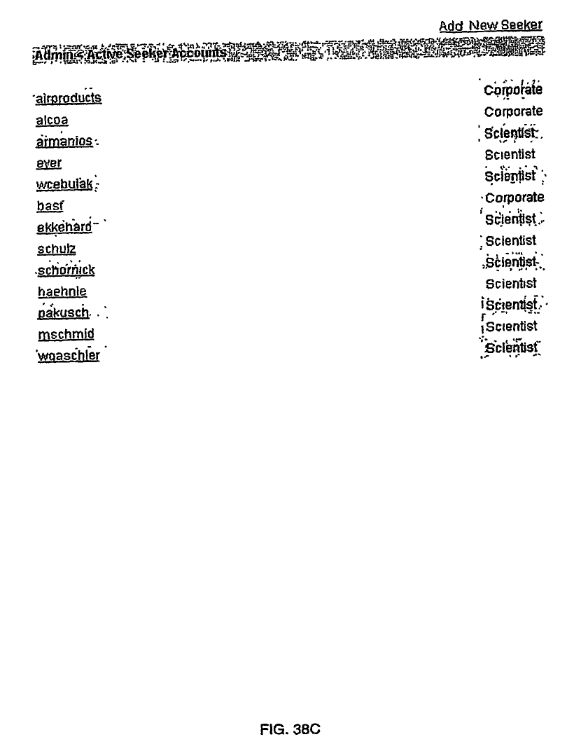

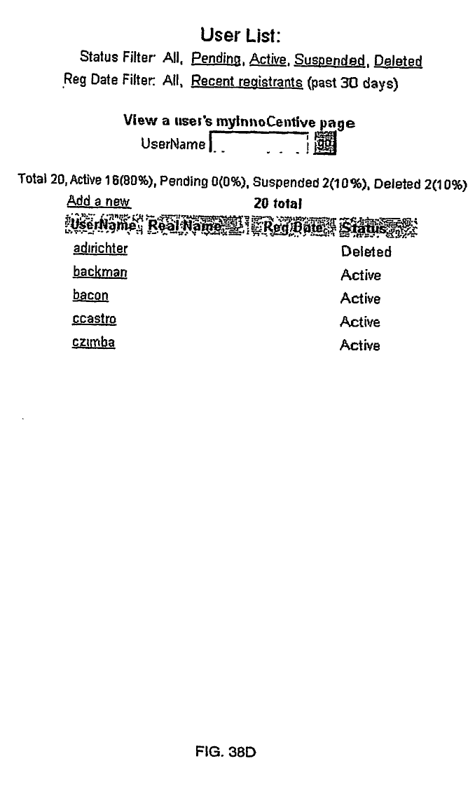

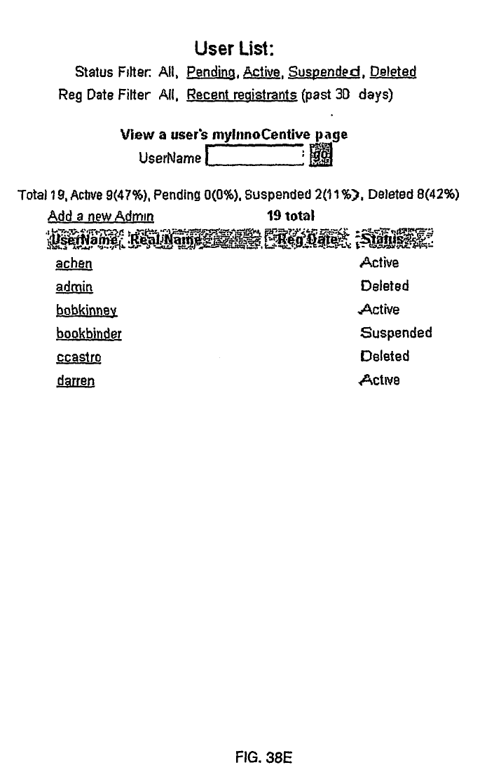

In some embodiments, clicking the “Solver” link may take a user to a table of registered Solvers, as illustrated in FIG. 38A. The table may be filtered by the Solvers' status and their registration date. The list may display Solvers who have recently registered. To display all Solvers, the user may click the “All” link in both the “Status Filter” area and the “Reg Date Filter” area.

In some embodiments, the two filters act in a logical “AND” fashion. So, to display only Pending Solvers who are recent registrants, you would click the “Pending” and “Recent Registrants” links.

According to the invention, to edit a Solver's profile or change his/her status, a user may click the username of the Solver, illustrated in FIG. 38B. Clicking the username displays the Solver's User Information page, described in the “Solver Search” section earlier in this document. There, the user can view the Solver's My Challenge page, make changes to the Solver's profile and status, reset the Solver's password, or resend the verification email.

In some embodiments, clicking the “Seeker” link takes the user to a table of registered Seeker Companies, as illustrated in FIG. 38C. The table may be filtered by the Seeker Company's status and their registration date. The list may display Seeker Companies who have recently been registered. To display all Seeker Companies, the user may click the “All” link in both the “Status Filter” area and the “Reg Date Filter” area.

In some embodiments, the two filters act in a logical “AND” fashion. So, to display only Active Seeker Companies who are recent registrants, you would click the “Active” and “Recent Registrants” links.

According to the invention, an Admin or an authorized intermediator can search for intermediators who can work on a Challenge/Solution. FIG. 38D illustrates a view of a list of intermediators and their status.

According to the invention, an Admin or an authorized intermediator can search for other Admins who can work on a Challenge/Solution. FIG. 38E illustrates a view of a list and their status.

According to another embodiment, the invention provides features and functions to enable a Seeker, a Solver, an intermediator or an Admin to register for using system 151.

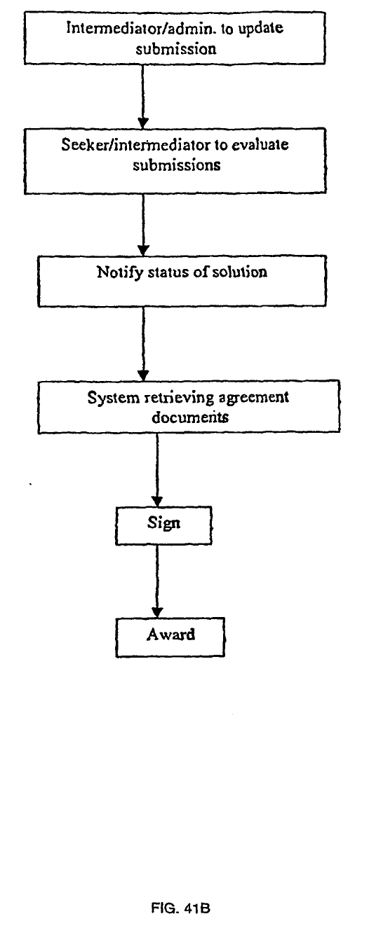

According to another aspect of the invention as illustrated in FIGS. 41A and 41B, a solver may view one or more challenges, as shown in operation 451. As shown in operation 453, a solver may select a challenge that he/she is interested in. If a solver is new to challenge processing system 151, the solver may register as shown in operation 457. The solver may input his/her background data, for example, contact information, residence information, subject matter expertise, etc., as part of the registration process. As shown in operation 459, after a solver registers in challenge processing system 151, the system may retrieve one or more solver specific agreement documents (e.g., confidentiality agreement document, intellectual property assignment agreement document) from an agreement database based on the information inputted by the solver. As shown in operation 461, a solver may sign or accept the retrieved agreement documents. After solver signing or accepting the agreement documents, an intermediator or an administrator in challenge processing system 151 may authorize the solver to access the challenges posted in the system. If a solver is already a registered member in challenge processing system 151, the solver may directly login the system. As shown in operation 463, the solver may access and view details of the selected challenges. As shown in operation 465, challenge processing system 151 may enable a solver to create a virtual private room or My Challenge room where a solver can organize or store the challenges he/she is interested in. As shown in operation 467, if the solver has any queries (e.g., additional required resources to solve the challenge, deadline, etc.) regarding the challenge, the solver may input queries using a query input tool in the virtual private room. In some embodiments, query input tool may be associated with the challenge.

As shown in operation 469, the solver may submit a solution for the challenge. Submission may include information related to, for example, materials and/or methods used for solving the challenge, results obtained, conclusion, suggestions etc. As shown in operation 471, an intermediator or an administrator may update or edit the solutions submitted by the solver. As shown in operation, a seeker and/or an intermediator may review or evaluate the solutions. In some embodiments, review or evaluation may be performed according to the solution criteria associated with the challenge. As shown in operation 475, a status of the solution (e.g., awarded, declined, etc.) may be notified to the solver. In some embodiments, the solver may be asked to submit further information for the submitted solution. In some embodiments, if the solver is awarded, the solver may be required to sign or accept one or more of additional agreement documents (e.g., intellectual property assignment). As shown in operation 477, challenge processing system 151 may retrieve solver specific additional agreement documents based on the background information inputted by the solver. As shown in operation 479, a solver may sign the retrieved agreement documents. In some embodiments, the solver may electronically sign or accept the agreement documents. As shown in operation 480, challenge processing system 151 may release the award to the solver who solved the challenge.

While a particular embodiment of the present invention has been described, it is to be understood that modifications will be apparent to those skilled in the art without departing from the spirit of the invention.

What is claimed is:

1. A system for enabling Seekers to create and post challenges for Solvers in a networked system, the system comprising a template driven interface that:
enables a user to select whether to create a new challenge or work with an existing challenge that has previously been stored, and if the user selects to create a new challenge, presents to the user a series of templates that prompts the user for input relating to the challenge to be created, the prompts including one or more of: an identification prompt; a background information prompt; a detailed information prompt regarding the challenge; a resources required prompt; an abstract of the challenge; a potential target Solvers information prompt; and a potential available resources prompt; receiving user input in response to the prompts; generating a challenge in response to the user input and system rules; and posting the challenge to a network.

2. The system of claim 1 wherein after the desired information is specified, the system can present a summary of the all entered information for review by the user in one screen.

3. The system of claim 1 wherein after the desired information is specified, the system can present a summary of the information entered for review by the user and a list of any attachments specified by the user.

4. The system of claim 2 wherein from the summary review screen, the user can approve or modify any of the previously entered information and save the information in a specified format.

5. The system of claim 4 wherein the system can provide the user an option to specify the format in which the document should be saved, where the document should be saved and a file name for the document.

6. The system of claim 1 wherein challenges previously prepared by the user can be saved and recalled by the user for subsequent modification and/or for use as a template for new challenges.

7. The system of claim 1 wherein once a challenge has been saved it can be posted to the network in accordance with the procedures established by the system operator.

8. The system of claim 1 wherein the identification prompt comprises user/Seeker identification and/or contact information.

9. The system of claim 1 wherein the background prompt comprises prompts to request background information related to the challenge including one or more of scientific background information, the company's history relating to the challenge and/or other background information

10. The system of claim 1 wherein the detailed information prompt prompts the user to insert related information regarding the challenge, including one or more of a detailed description, supporting information, solution criteria. award and/or other detailed information.

11. The system of claim 1 wherein an attachment prompt provides a user to facilitate the ability to attach existing documents or documents created using a separate application that are stored on a hard drive, network drive or otherwise stored but accessible to the user.

12. The system of claim 1 wherein the prompts further including a discipline specification prompt that requests the user to specify one or more disciplines to which the challenge relates and/or specific categories within the disciplines.

13. The system of claim 1 wherein the posted challenge is used as a template for future challenges.
